(19) United States
(12) Patent Application Publication
(10) Pub. No.: US 2026/0122594 A1
(43) Pub. Date: Apr. 30, 2026

(54) METHOD OF USER EQUIPMENT (UE), METHOD OF COMMUNICATION APPARATUS, UE AND COMMUNICATION APPARATUS

(71) Applicant: NEC Corporation, Minato-ku, Tokyo (JP)

(72) Inventors: Kundan TIWARI, Bengaluru (IN); Toshiyuki TAMURA, Ibaraki (JP); Iskren IANEV, Reading (GB)

(73) Assignee: NEC Corporation, Minato-ku, Tokyo (JP)

(21) Appl. No.: 19/120,985

(22) PCT Filed: Oct. 30, 2023
(86) PCT No.: PCT/JP2023/039109

§ 371 Date: Apr. 14, 2025

(30) Foreign Application Priority Data
Nov. 2, 2022 (IN) 202211062529

(51) Int. Cl. H04W 60/00; H04W 84/04

(52) U.S. Cl. CPC H04W 60/002; H04W 84/042

(57) ABSTRACT

An aspect of this disclosure includes a method of a User Equipment (UE). The method includes sending a first message to a communication apparatus in a first Visited Public Land Mobile Network (VPLMN). The first message includes a request for first information. The first information indicates a network slice which is available in a second VPLMN. The second VPLMN is different from the first VPLMN. The method includes performing PLMN selection in a case of not receiving the first information.

### TECHNICAL FIELD

The present disclosure relates to a method of a User Equipment (UE), a method of a communication apparatus, a UE and a communication apparatus.

### BACKGROUND ART

There is a following service requirement defined in 3GPP TS 22.261 [2].

For a roaming UE activating a service/application requiring a network slice not offered by the serving network but available in the area from other network(s), the HPLMN shall be able to provide the UE with prioritization information of the VPLMNs with which the UE may register for the network slice.

### CITATION LIST

### Non Patent Literature

NPL 1: 3GPP TR 21.905: Vocabulary for 3GPP Specifications. V17.1.0 (2021-12)
NPL 2: 3GPP TS 22.261: “Service requirements for the 5G system” V19.0.0 (2022-09)
NPL 3: 3GPP TS 23.501: “System architecture for the 5G System (5GS)”. V17.6.0 (2022-09)
NPL 4: 3GPP TS 23.502: “Procedures for the 5G System (5GS)”. V17.6.0 (2022-09)
NPL 5: 3GPP TR 23.700-41: “Study on enhancement of network slicing; Phase 3”. V1.0.0 (2022-09)
NPL 6: 3GPP TS 23.122: “(MS) in idle mode”. V18.0.0 (2022-09)
NPL 7: 3GPP TS 23.003: “Numbering, addressing and identification”. V17.7.0 (2022-09)
NPL 8: 3GPP TS 38.413: “NG-RAN; NG Application Protocol (NGAP)”. V17.2.0 (2022-09)
NPL 9: IETF RFC 5580: “Carrying Location Objects in RADIUS and Diameter”. (2009-08)

### SUMMARY OF INVENTION

### Technical Problem

3GPP SA WG2 has been working for a feasibility study on the requirement in 3GPP TS 22.261 [2] and generating a report in 3GPP TR 23.700-41 [5]. In the SA2 #153e meeting, 3GPP SA WG2 agreed the following technical enhancements to comply to the requirements in 3GPP TS 22.261 [2].

A slice based SoR mechanism to deliver enhanced slice-aware SoR information will reuse the current SoR mechanism defined in TS 23.122 [6] for SoR information delivery.

The SoR container (which is used also to carry the enhanced slice-aware SoR information) from the UDM to the UE is security protected. UDM requires knowing the support of the enhanced SoR information by the UE to deliver the enhanced slice-aware SoR information to the UE.

This disclosure focuses on a problem that may exist in the third agreement in the above bullets. For example, when the UE indicates its support of the enhanced SoR to the UDM in the Home Public Land Mobile Network (HPLMN), any entity in a Visited Public Land Mobile Network (VPLMN) may remove that indicator as it may be beneficial for the VPLMN. The VPLMN may remove or ignore the indicator (e.g., an indicator that the UE supports the enhanced SoR) to make the UE to stay in the VPLMN. For example, from the VPLMN point of view, the VPLMN makes a business with the HPLMN as far as outbound roamers from the HPLMN stay in the VPLMN and the VPLMN may want the UE to stay the VPLMN. In addition, for example, mechanism regarding the enhanced SoR may not work well in a case where the VPLMN does not support the enhanced SoR.

As the result of this improper intervention by the VPLMN or due to the VPLMN which does not support the enhanced SoR, the outbound roamers may not get service(s) that is only available with a network slice but that network slice is not available in the VPLMN while such network slice are available in another VPLMN(s). This may cause a serious inconvenience to users as requested services may not be available while the user is roaming.

### Solution to Problem

A method of a User Equipment (UE) according to example aspect of this disclosure includes sending a first message to a communication apparatus in a first Visited Public Land Mobile Network (VPLMN). The first message includes a request for first information. The first information indicates a network slice which is available in a second VPLMN. The second VPLMN is different from the first VPLMN. The method includes performing PLMN selection in a case of not receiving the first information.

A method of a communication apparatus in a first Visited Public Land Mobile Network (VPLMN) according to example aspect of this disclosure includes receiving a first message. The first message includes a request for first information. The first information indicates a network slice which is available in a second VPLMN. The method includes sending the request to another communication apparatus. The method includes sending the first information in a case of receiving the first information from the another communication apparatus. The method includes sending a second message including second information in a case of not receiving the first information from the another communication apparatus. The second information indicates that the communication apparatus is configured to recognize the request.

A method of a User Equipment (UE) according to example aspect of this disclosure includes sending a first message to a communication apparatus in a first Visited Public Land Mobile Network (VPLMN). The first message includes a request for first information. The first information indicates a network slice which is available in a second VPLMN. The second VPLMN is different from the first VPLMN. The method includes performing a registration procedure over non-3GPP access in a case of not receiving the first information.

A User Equipment (UE) according to example aspect of this disclosure includes a memory, and at least one hardware processor coupled to the memory. The at least one hardware processor is configured to send a first message to a communication apparatus in a first Visited Public Land Mobile Network (VPLMN). The first message includes a request for first information. The first information indicates a network slice which is available in a second VPLMN. The second VPLMN is different from the first VPLMN. The at least one hardware processor is configured to perform PLMN selection in a case of not receiving the first information.

A communication apparatus in a first Visited Public Land Mobile Network (VPLMN) according to example aspect of this disclosure includes a memory, and at least one hardware processor coupled to the memory. The at least one hardware processor is configured to receive a first message. The first message includes a request for first information. The first information indicates a network slice which is available in a second VPLMN. The at least one hardware processor is configured to send the request to another communication apparatus. The at least one hardware processor is configured to send the first information in a case of receiving the first information from the another communication apparatus. The at least one hardware processor is configured to send a second message including second information in a case of not receiving the first information from the another communication apparatus. The second information indicates that the communication apparatus is configured to recognize the request.

A User Equipment (UE) according to example aspect of this disclosure includes a memory, and at least one hardware processor coupled to the memory. The at least one hardware processor is configured to send a first message to a communication apparatus in a first Visited Public Land Mobile Network (VPLMN). The first message includes a request for first information. The first information indicates a network slice which is available in a second VPLMN. The second VPLMN is different from the first VPLMN. The at least one hardware processor is configured to perform a registration procedure over non-3GPP access in a case of not receiving the first information.

### Advantageous Effects of Invention

An example object of this disclosure is to provide a method and apparatus that can solve the above problem.

### BRIEF DESCRIPTION OF DRAWINGS

FIG. 1 is a signaling diagram of a First example of the First Aspect.

FIG. 2 is is a signaling diagram of a Second example of the First Aspect.

FIG. 3 is a diagram illustrating a system overview.

FIG. 4 is a block diagram illustrating a UE.

FIG. 5 is a block diagram illustrating an (R)AN node.

FIG. 6 is a diagram illustrating System overview of (R)AN node based on O-RAN architecture.

FIG. 7 is a block diagram illustrating an RU.

FIG. 8 is a block diagram illustrating a DU.

FIG. 9 is a block diagram illustrating a CU.

FIG. 10 is a block diagram illustrating an AMF.

FIG. 11 is a block diagram illustrating a PCF.

FIG. 12 is a block diagram illustrating an AUSF.

FIG. 13 is a block diagram illustrating a UDM.

FIG. 14 is a block diagram illustrating an N3IWF.

FIG. 15 is a signaling diagram of another example.

### DESCRIPTION OF EMBODIMENTS

### Abbreviations

For the purposes of the present document, the abbreviations given in 3GPP TR 21.905 [1] and the following apply. An abbreviation defined in the present document takes precedence over the definition of the same abbreviation, if any, in 3GPP TR 21.905 [1].
4G-GUTI 4G Globally Unique Temporary UE Identity
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QoS Identifier
AF Application Function
AMF Access and Mobility Management Function
AMF-G Geographically selected Access and Mobility Management Function
AMF-NG Non-Geographically selected Access and Mobility Management Function
AS Access Stratum
ATSSS Access Traffic Steering, Switching, Splitting
ATSSS-LL ATSSS Low-Layer
AUSF Authentication Server Function
AUTN Authentication token
BCCH Broadcast Control Channel
BMCA Best Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Plane
DAPS Dual Active Protocol Stacks
DL Downlink
DN Data Network
DNAI DN Access Identifier
DNN Data Network Name
DRX Discontinuous Reception
DS-TT Device-side TSN translator
ePDG evolved Packet Data Gateway
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
GPSI Generic Public Subscription Identifier
GUAMI Globally Unique AMF Identifier
GUTI Globally Unique Temporary UE Identity
HPLMN Home Public Land Mobile Network
HR Home Routed (roaming)
IAB Integrated access and backhaul
IMEI/TAC IMEI Type Allocation Code
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
MCC Mobile country code
MCX Mission Critical Service
MDBV Maximum Data Burst Volume
MFBR Maximum Flow Bit Rate
MICO Mobile Initiated Connection Only
MITM Man In the Middle
MNC Mobile Network Code
MPS Multimedia Priority Service
MPTCP Multi-Path TCP Protocol
N3IWF Non-3GPP InterWorking Function
N3GPP Non-3GPP access
N5CW Non-5G-Capable over WLAN
NAI Network Access Identifier
NAS Non-Access-Stratum
NEF Network Exposure Function
NF Network Function
NGAP Next Generation Application Protocol
NID Network identifier
NPN Non-Public Network
NR New Radio
NRF Network Repository Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NSSRG Network Slice Simultaneous Registration Group
NW-TT Network-side TSN translator
NWDAF Network Data Analytics Function
PCF Policy Control Function
PDB Packet Delay Budget
PDR Packet Detection Rule
PDU Protocol Data Unit
PEI Permanent Equipment Identifier
PER Packet Error Rate
PFD Packet Flow Description
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QoE Quality of Experience
RACS Radio Capabilities Signalling optimisation
(R)AN (Radio) Access Network
RAT Radio Access Technology
RG Residential Gateway
RIM Remote Interference Management
RQA Reflective QoS Attribute
RQI Reflective QoS Indication
RSN Redundancy Sequence Number
SA NR Standalone New Radio
SBA Service Based Architecture
SBI Service Based Interface
SCP Service Communication Proxy
SD Slice Differentiator
SEAF Security Anchor Functionality
SEPP Security Edge Protection Proxy
SMF Session Management Function
SMSF Short Message Service Function
SN Sequence Number
SN name Serving Network Name.
SNPN Stand-alone Non-Public Network
S-NSSAI Single Network Slice Selection Assistance Information
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TMSI Temporary Mobile Subscriber Identity
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMF UE radio Capability Management Function
UDM Unified Data Management
UDR Unified Data Repository
UDSF Unstructured Data Storage Function
UE User Equipment
UL Uplink
UL CL Uplink Classifier
UPF User Plane Function
URLLC Ultra Reliable Low Latency Communication
URRP-AMF UE Reachability Request Parameter for AMF
URSP UE Route Selection Policy
VID VLAN Identifier
VLAN Virtual Local Area Network
VPLMN Visited Public Land Mobile Network
W-5GAN Wireline 5G Access Network
W-5GBAN Wireline BBF Access Network
W-5GCAN Wireline 5G Cable Access Network
W-AGF Wireline Access Gateway Function

### Definitions

For the purposes of the present document, the terms and definitions given in 3GPP TR 21.905 [1] and the following apply. A term defined in the present document takes precedence over the definition of the same term, if any, in 3GPP TR 21.905 [1].

### General

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended.

Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects and elements included in each Aspects described below may be implemented independently or in combination with any other. These Aspects include novel characteristics different from one another. Accordingly, these Aspects contribute to achieving objects or solving problems different from one another and contribute to obtaining advantages different from one another.

In the all aspects defined below, an uplink SoR container or a downlink SoR container may be integrity protected using a security key Kausf or any key generated from Kausf. The uplink SoR container contains a MAC header as derived below.

Uplink SoR MAC Header (e.g., the MAC header in the uplink SoR container) is derived using at least one of the following parameters:
1) Kausf,
2) Uplink SoR container counter.
3) Length of the SoR container counter.

When a NF in HPLMN (e.g., UDM or SoR-AF or AUSF) receives the uplink SoR container, the NF checks the Uplink SoR MAC Header. If the received Uplink SoR MAC Header is not as expected, the uplink SoR container is dropped. Otherwise (e.g., if the NF determines that the received Uplink SoR MAC Header is expected one by the checking), the NF processes the uplink SoR container

Downlink SoR MAC Header is added to a downlink SoR container and is derived using at least one of the following parameters:
1) Kausf,
2) Downlink SoR container counter.
3) Length of the SoR container counter.

When a UE receives the downlink SoR container, the UE checks the downlink SoR MAC Header. If the received Downlink SoR MAC Header is not as expected, the Uplink SoR container is dropped. Otherwise (e.g., if the UE determines that the received Downlink SoR MAC Header is expected one by the checking) the UE processes the downlink SoR container.

### FIRST ASPECT

In order to make a HPLMN operator possible to provide prioritization information for VPLMN(s)) to a UE while the UE is roaming, it needs a mechanism in 3GPP TS 23.501 [3], 3GPP TS 23.502 [4] and other 3GPP specifications so that a UDM provides the prioritization information for the VPLMN(s) to the UE based on the location that the UE moved to. In addition, it needs a mechanism so that the UE can move to another VPLMN in a case where the UE recognize that the prioritization information for VPLMN(s) cannot be provided in the current VPLMN. The prioritization information may be expressed as Slice Availability information or a list of PLMN(s) in this disclosure.

This First Aspect discloses a mechanism that enables the UE to request for obtaining a list of PLMN(s) available at the UE location based on network slice and the UE can confirm whether the request is properly processed in the VPLMN as well as in the HPLMN. In addition, this First Aspect discloses a mechanism that enables the UE to move to another VPLMN in a case where the UE recognize that the prioritization information for VPLMN(s) cannot be provided in the current VPLMN.

In order to provide the Slice Availability feature (the Slice Availability feature may be expressed as the slice based SoR mechanism), the UE, the VPLMN and the HPLMN need to be enhanced. I.E., if at least one of the UE, the VPLMN and the HPLMN has not yet enhanced to support the Slice Availability feature, the Slice Availability feature does not work.

The table 1 indicates a possible combination with regard to a support of the Slice Availability feature.

TABLE 1
a combination on support of the slice based SoR mechanism

| Combination number | UE | VPLMN | HPLMN |
|---|---|---|---|
| 1 | Not supported | — | — |
| 2 | Supported | Not supported | Not supported |
| 3 | Supported | Supported | Not supported |
| 4 | Supported | Not supported | Supported |
| 5 | Supported | Supported | Supported |

While the main focus of the first aspect is the combination number 5 with improper behavior in the VPLMN, the First Aspect also effectively works to other combinations (e.g., the combination number 4). For example, the VPLMN with improper behavior may ignore the indicator indicating that the UE supports the Slice Availability feature. For example, the VPLMN with improper behavior may not send or may discard the prioritization information to be sent to the UE. In these cases, the prioritization information may not be sent to the UE properly.

Note that the slice based SoR mechanism may be expressed as Slice Availability feature or network slice availability feature in this disclosure.

Note that Slice Availability feature or network slice availability feature may be expressed as the slice based SoR mechanism in this disclosure.

In order to make the First example of the First Aspect understandable, the First example of the First Aspect takes the following examples.

### For a UE 3:

The UE 3 has four applications installed, APL 1, APL 2, APL 3 and APL 4 and these applications are associated with network slice S-NSSAI 1, S-NSSAI 2, S-NSSAI 3 and S-NSSAI 4 respectively based on a URSP rule in the UE 3. For example, these applications may be associate with a network slice identified by S-NSSAI 1, a network slice identified by S-NSSAI 2, a network slice identified by S-NSSAI 3 and a network slice identified by S-NSSAI 4 respectively. S-NSSAI may mean a network slice identified by the S-NSSAI in this disclosure.

The UE 3 has three applications, APL 1, APL 2 and APL 3 active when the UE 3 initiates a Registration Procedure to VPLMN 1. I.E., the UE 3 is interested in network slices S-NSSAI 1, S-NSSAI 2 and S-NSSAI 3 to be allowed to access by the VPLMN 1. The application(s) may be expressed as service(s). The application(s) may correspond service(s). For example, the UE 3 may activate APL 1, require Service 1 corresponding to APL 1 and perform a Registration Procedure corresponding to S-NSSAI 1.

### For VPLMN 1:

A Cell 501 supports network slices S-NSSAI 1 and S-NSSAI 2. For example, the Cell 501 is controlled by a (R)AN node 5 (e.g., an NG-RAN node, or a gNB) in the VPLMN 1.

### For HPLMN of the UE 3:

A UDM 75 has a subscriber data for the UE 3 including S-NSSAI 1, S-NSSAI 2, S-NSSAI 3 and S-NSSAI 4 in subscribed NSSAI for the UE 3.

For example, the UDM 75 is included in the HPLMN.

### First Example of the First Aspect

First example of the First Aspect discloses, for example, a method where a UDM 75 provides prioritization information for the VPLMN(s) with network slice related information to a UE 3 in a Registration Procedure.

In addition, for example, the First example of the First Aspect discloses a mechanism where the UE 3 provides an explicit indication on the request for obtaining a list of PLMN(s) available at the UE location based on network slice and relevant VPLMN related information to the UDM 75 during the Registration Procedure.

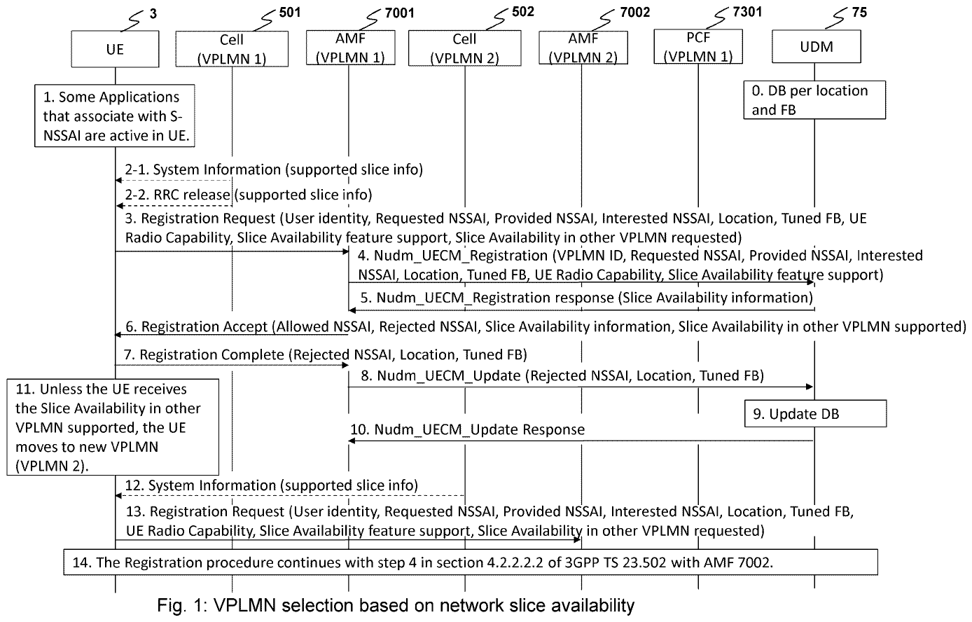

The detailed processes of the First example of the First Aspect are as described below, with reference to FIG. 1.

Step 0. The UDM 75 in the HPLMN holds a Database (DB) based on an operator roaming agreement among roaming partners all over the world. The DB information (or the DB) may include a list of roaming partners per location. The list of roaming partners may be expressed as a list of VPLMN(s). For example, the HPLMN has a roaming partners VPLMN 1, VPLMN 2, and VPLMN 3 in one area (e.g., in Tokyo, Japan) with the priority order. For example, the list of roaming partners (or the list of VPLMN(s)) includes VPLMN 1, VPLMN 2, and VPLMN 3 in Tokyo, Japan with the priority order.

For each VPLMN entry in the list, the UDM 75 may hold S-NSSAI(s) available (i.e., S-NSSAI(s) supported by the VPLMN) in the location together with Frequency Band(s) (FB(s)). For example, in VPLMN 1 in Tokyo S-NSSAI 1 and S-NSSAI 2 are available with 900 MHz Frequency Band. For example, the UDM 75 holds information indicating that S-NSSAI 1 and S-NSSAI 2 are available with 900 MHz Frequency Band in VPLMN 1 in Tokyo. For example, for each VPLMN entry in the list the UDM 75 may hold S-NSSAI(s) available in the location. For example, for each VPLMN entry in the list the UDM 75 may hold S-NSSAI(s) available in the location per RAN type. For example, the RAN type may be RAT type. In this disclosure, the RAT type may indicate a type of RAT which the UE 3 uses. For example, the RAT type may indicate 4G, E-UTRA, E-UTRAN, 5G, NR and so on.

This DB is basically managed by an Operation and Maintenance (O&M) process. In addition to the O&M process, an HPLMN operator uses dynamic DB update based on an update mechanism as disclosed by this disclosure.

In addition, the UDM 75 has a subscriber data for the UE 3 including S-NSSAI 1, S-NSSAI 2, S-NSSAI 3 and S-NSSAI 4 in a subscribed NSSAI for the UE 3.

Step 1. The UE 3, as an inbound roamer for a VPLMN 1 has some applications active in the UE 3. Based on a URSP rule in the UE 3, the UE 3 knows which S-NSSAI(s) it needs to request to the VPLMN 1 in the Registration procedure. For example, there are four applications, APL 1, APL 2, APL 3 and APL 4 installed in the UE 3. Out of the four applications, there are three applications APL 1, APL 2 and APL 3 active and S-NSSAI 1, S-NSSAI 2 and S-NSSAI 3 are associated network slices to each application respectively based on the URSP rule in the UE 3.

Step 2-1. The UE 3 may receive, from a Cell 501, system information indicating a list of supported S-NSSAI(s) by the Cell 501. The Cell 501 may be expressed as a (R)AN node, an NG-RAN node or a gNB controlling the Cell 501. For example, the Cell 501 supports S-NSSAI 1 and S-NSSAI 2. For example, in a case where the Cell 501 supports S-NSSAI 1 and S-NSSAI 2, the system information indicates (or includes) the list which includes S-NSSAI 1 and S-NSSAI 2. For example, the system information includes the slice info which includes S-NSSAI 1 and S-NSSAI 2.

Step 2-2. The UE 3 may receive information of a list of supported S-NSSAI(s) by the Cell 501 in an RRC message. The RRC message may be an RRC release message or existing other RRC messages. For example, the Cell 501 supports S-NSSAI 1 and S-NSSAI 2. For example, in a case where the Cell 501 supports S-NSSAI 1 and S-NSSAI 2, the RRC message includes the list which includes S-NSSAI 1 and S-NSSAI 2. For example, the RRC message includes the slice info which includes S-NSSAI 1 and S-NSSAI 2. For example, the UE 3 may receive at least one of the system information in step 2-1 and the RRC message in step 2-2.

Step 3. The UE 3 sends a Registration Request message to an AMF 7001 including User identity, Requested NSSAI, Provided NSSAI, Interested NSSAI, Location, Tuned FB, UE Radio Capability, Slice Availability feature support and Slice Availability in other VPLMN requested parameters. The Registration message may include at least one of these parameters. The ‘Slice Availability in other VPLMN requested’ may be expressed as ‘Slice Availability in other VPLMN requested’ parameter in this disclosure. The AMF 7001 is located in VPLMN 1. The following bullets explain each parameter in details.
User Identity may be a 5G-GUTI, SUCI or SUPI. For example, the User Identity may be a 5G-GUTI, SUCI or SUPI for the UE 3.
Requested NSSAI includes a list of S-NSSAI(s) that the UE 3 wishes to request to the VPLMN 1. In this example, the UE 3 populates S-NSSAI 1 and S-NSSAI 2 to the Requested NSSAI as the UE 3 knows, based on step 2-1 or step 2-2, that S-NSSAI 1 and S-NSSAI 2 are the network slices available in the Cell 501. I.E., although the UE 3 also wishes to request S-NSSAI 3 because an associated APL 3 is active in the UE 3, the UE 3 does not request the S-NSSAI 3 as it is unlikely to be accepted by the AMF 7001 due to no support of the S-NSSAI 3 by the Cell 501. In this example the Requested NSSAI includes S-NSSAI 1 and S-NSSAI 2.
Provided NSSAI or any other notation for NSSAI which may include a list of S-NSSAI(s) that are available in a cell of the VPLMN 1 where the UE 3 is camped on. In this example the UE 3 may populate S-NSSAI 1 and S-NSSAI 2 based on information received in step 2-1 and step 2-2. In this example, the Provided NSSAI includes S-NSSAI 1 and S-NSSAI 2.

In one example, each S-NSSAI in the Provided NSSAI may have an associated information such as a list of FB(s) on which the S-NSSAI is available or deployed in the VPLMN 1. The UE 3 may obtain the Provided NSSAI in each FB by listening to a system information over each FB that the VPLMN 1 provides. The Provided NSSAI may be expressed as available S-NSSAI(s). For example, the UE 3 may associate the FB which the system information is broadcasted with the Provided NSSAI.

In another example each S-NSSAI in the Provided NSSAI may have an associated information such as a list of FB(s) together with RAT type.

In another example each S-NSSAI in the Provided NSSAI may have an associated information such as a list of FB(s) together with VPLMN ID that S-NSSAI is available in another VPLMN(s). The UE 3 may obtain available S-NSSAI(s) in FB in each VPLMN by listening a system information over each FB in each VPLMN.

Note that each S-NSSAI in the Provided NSSAI may have an associated information such as a combination of FB, RAT type and PLMN ID. For example, each S-NSSAI in the Provided NSSAI is associated with at least one of FB, RAT type and PLMN ID. The PLMN ID may be VPLMN ID.
Interested NSSAI or any other notation for NSSAI which may include a list of S-NSSAI(s) that UE 3 is interested in. In this example the UE 3 may populate S-NSSAI 1, S-NSSAI 2 and S-NSSAI 3 as APL 1, APL 2 and APL 3 are active in the UE 3. For example, the Interested NSSAI may include S-NSSAI 1, S-NSSAI 2 and S-NSSAI 3. In one example the Interested NSSAI includes the S-NSSAI which the UE 3 wants to register to the VPLMN 1 but the S-NSSAI is not provided by the cell which the UE 3 is camped on. For example, the Interested NSSAI may include S-NSSAI 3.
Location may be the location of the UE 3. Location can be a geographical location of the UE 3. For example, Location can be a Tracking Area Identity (TAI), NR Cell Global Identity (NCGI) as defined in the 3GPP TS 23.003 [7], NR Cell Identity (NCI) as defined in the 3GPP TS 23.003 [7], E-UTRAN Cell Global Identifier (ECGI) as defined in the 3GPP TS 23.003 [7], Global Cable Identifier (GCI) as defined in the 3GPP TS 23.003 [7], a general City name, zip-code, formed with GPS location or a location expressed with civic and geospatial location formats as defined in IETF RFC 5580 [9].
Tuned FB is a Frequency Band that the UE 3 is currently tuned to. For example, Tuned FB is 800 MHz, 900 MHz or 6 GHz.

In one example, Tuned FB may have an associated information such as a RAT type.
UE Radio Capability indicates Frequency Bands that the UE 3 supports. The UE Radio Capability may also indicate a combination of Frequency Band and RAT type that UE 3 supports.
Slice Availability feature support parameter or any other notation for a parameter which indicates that the UE 3 supports the network slice availability feature.

I.E., when the UE 3 receives a Slice Availability information from the UDM 75 via the AMF 7001, the UE 3 is able to process the Slice Availability information and to select a VPLMN based on outcome of the process of the received Slice Availability information. For example, the network slice availability feature indicates that the UE 3 is able to process the Slice Availability information and to select a VPLMN based on outcome of the process of the received Slice Availability information. Processing the Slice Availability information and selecting a VPLMN based on outcome of the process of the received Slice Availability information are described below.

The Slice Availability feature support parameter may be expressed as Slice Availability feature support. The Slice Availability information may be expressed as network slice availability information in this disclosure.
Slice Availability in other VPLMN requested parameter or any other notation for a parameter which indicates that the UE 3 requires the network slice availability information from the HPLMN. The ‘Slice Availability in other VPLMN requested’ parameter may indicate that the UE 3 requires or requests the network slice availability information. For example, the ‘Slice Availability in other VPLMN requested’ parameter indicates what network slice(s) by which VPLMN(s) are supported in the UE 3's location. For example, the ‘Slice Availability in other VPLMN requested’ parameter may indicate that the UE 3 requires or requests information related to (or information indicating) network slice(s) supported by VPLMN(s) corresponding to the UE 3's location (e.g., current location of the UE 3). The ‘Slice Availability in other VPLMN requested’ parameter may indicate that the UE 3 requires or requests the Slice Availability information. The ‘Slice Availability in other VPLMN requested’ parameter may be a request for the Slice Availability information. The Slice Availability information is described below.

Step 4. The AMF 7001 sends an Nudm_UECM_Registration message to the UDM 75 including VPLMN ID, Requested NSSAI, Provided NSSAI, Interested NSSAI, Location, Tuned FB, UE Radio Capability and Slice Availability feature support parameter. Instead of the Nudm_UECM_Registration message, the AMF 7001 may send an Nudm_UECM_Registration Request message to the UDM 75 including VPLMN ID, Requested NSSAI, Provided NSSAI, Interested NSSAI, Location, Tuned FB, UE Radio Capability and Slice Availability feature support parameter. The AMF 7001 may include at least one of Requested NSSAI, Provided NSSAI, Interested NSSAI, Location, Tuned FB, UE Radio Capability and Slice Availability feature support parameter if the AMF 7001 receives the Slice Availability feature support parameter and ‘Slice Availability in other VPLMN requested’ parameter in the Registration Request message in step 3. The following bullets explain in detail each parameter.
VPLMN ID indicates a VPLMN which the UE 3 is registering to. For example, the VPLMN ID may be identity of the VPLMN 1 where the UE 3 is registering to. For example, the VPLMN ID indicates VPLMN 1 where the UE 3 is registering to.
Location may be the same as the Location in step 3. The AMF 7001 may generate Location parameter based on an information from the Cell 501. In this case, the Location may be a NCGI, NCI, TAI, N3IWF user location information, TNGF user location information, TWIF user location information, W-AGF user location information as defined in 3GPP TS 38.413 [8].
Requested NSSAI, Provided NSSAI, Interested NSSAI, Tuned FB, UE Radio Capability, and Slice Availability feature support in step 4 may be the same as the ones in step 3. The ‘Slice Availability in other VPLMN requested’ parameter may be included in the Nudm_UECM_Registration message. The ‘Slice Availability in other VPLMN requested’ parameter in step 4 may be same one in step 3.

For example, the AMF 7001 may send the Nudm_UECM_Registration message in a case where the AMF 7001 receives, from the UE 3, the Registration Request message or any existing message between AMF and UE or a new message between AMF and UE.

Step 5. Based on information received in step 4, the UDM 75 updates the DB related to supported network slice information in VPLMN(s). For example, in a case where the UDM 75 receives the VPLMN ID 1 which identifies VPLMN 1 and Location which is set to Tokyo and Provided NSSAI including S-NSSAI 1 and S-NSSAI 2, the UDM 75 adds or updates an entry related to the VPLMN 1 in the list of roaming partners (or the list of VPLMN(s)). In this case, for example, the UDM 75 adds, to the list, the entry which indicates that S-NSSAI 1 and S-NSSAI 2 are available in VPLMN 1 in Tokyo. For example, in a case where the UDM 75 has already stored the entry regarding VPLMN 1, the UDM 75 updates the entry based on received information which indicates that S-NSSAI 1 and S-NSSAI 2 are available in VPLMN 1 in Tokyo. In addition, for example, in case of adding or updating the entry, the UDM 75 associates Frequency Band indicated by Tuned FB with the entry. For example, in a case where the Tuned FB indicates 800 MHz, the UDM adds, to the list, the entry which indicates that S-NSSAI 1 and S-NSSAI 2 are available on 800 MHz in VPLMN 1 in Tokyo.

The UDM 75 sends an Nudm_UECM_Registration response message to the AMF 7001 including Slice Availability information if the Slice Availability feature support parameter is included in the Nudm_UECM_Registration message in step 4. The UDM 75 generates the Slice Availability information based on at least one of the received parameters in the Nudm_UECM_Registration message in step 4 and information in the DB. The Slice Availability information indicates S-NSSAI(s) that are available to the UE 3 in the location where the UE 3 is located. For example, the Slice Availability information may take one of the following forms. For example, the Slice Availability information may take one of the following forms such as “Prioritized list of VPLMN(s) with supported S-NSSAI(s)”, “Prioritized list of VPLMN(s) with supported S-NSSAI(s) together with FB information”, “Prioritized list of VPLMN(s) with supported S-NSSAI(s) together with FB information with location for entire coverage of the VPLMN” and

“Prioritized list of VPLMN(s) with supported S-NSSAI(s) based on the subscribed NSSAI”.
Prioritized list of VPLMN(s) with supported S-NSSAI(s). The prioritized list of VPLMN(s) may be generated by the UDM 75 based on VPLMN ID, the location, the Provided NSSAI and Interested NSSAI that are received in step 4. For example, based on VPLMN ID, the location, the Provided NSSAI and Interested NSSAI that are received in step 4, the UDM 75 is aware that the UE 3 is interested in S-NSSAI 1, S-NSSAI 2 and S-NSSAI 3 but the VPLMN 1 identified by the VPLMN ID may only allow S-NSSAI 1, S-NSSAI 2 to the UE 3. With this situation, the UDM 75 may choose VPLMN(s) that supports all of S-NSSAI 1, S-NSSAI 2 and S-NSSAI 3 and generates the prioritized list based on the roaming agreements with VPLMN(s). For example, the prioritized list of VPLMN(s) includes VPLMN(s) that supports all of S-NSSAI 1, S-NSSAI 2 and S-NSSAI 3 on the location. For example, the prioritized list of VPLMN(s) may indicate VPLMN 2 that supports all of S-NSSAI 1, S-NSSAI 2 and S-NSSAI 3 on the location.
Prioritized list of VPLMN(s) with supported S-NSSAI(s) together with FB information. In addition to the bullet above, the UDM 75 takes the Provided NSSAI with FB and UE Radio Capability into account. For example, the prioritized list of VPLMN(s) includes VPLMN(s) that supports all of S-NSSAI 1, S-NSSAI 2 and S-NSSAI 3 on Tuned FB and the location received in step 4. As this example provides the VPLMN together with FB information, the UE 3 can tune to a cell with the indicated FB in the indicated VPLMN. For example, the prioritized list of VPLMN(s) may indicate VPLMN 2 that supports all of S-NSSAI 1, S-NSSAI 2 and S-NSSAI 3 on the location and Tuned FB.
Prioritized list of VPLMN(s) with supported S-NSSAI(s) together with FB information with location for entire coverage of the VPLMN. In this example, the UDM 75 does not take Location information in step 4 into account. Instead, the UDM 75 generates a full set of Prioritized list of VPLMN(s) with supported S-NSSAI(s) together with FB information per locations where the VPLMN covers. The advantage of this example is that the UE 3 does not have to obtain the Slice Availability information as far as the UE 3 stays in the same VPLMN as full set of Prioritized list of VPLMN(s) is provided to the UE 3. A value of the Location may be the same as the Location in step 3. For example, the prioritized list of VPLMN(s) may indicate S-NSSAI(s) available in VPLMN 2 per location and FB. For example, the prioritized list of VPLMN(s) may indicate that first S-NSSAI is available on a first location and 800 MHz in a first VPLMN, and second S-NSSAI is available on the first location and 900 MHz in the first VPLMN, and third S-NSSAI is available on a second location and 800 MHz in the first VPLMN, and fourth S-NSSAI is available on the second location and 900 MHz in the first VPLMN, and fifth S-NSSAI is available on the first location and 800 MHz in a second VPLMN, and sixth S-NSSAI is available on the first location and 900 MHz in the second VPLMN, and seventh S-NSSAI is available on the second location and 800 MHz in the second VPLMN, and eighth S-NSSAI is available on the second location and 900 MHz in the second VPLMN.
Prioritized list of VPLMN(s) with supported S-NSSAI(s) based on the subscribed NSSAI. In this example, the UDM 75 takes the Requested NSSAI in step 4 and the subscribed NSSAI in the UDM 75 into account. When the UDM 75 refers to both the Requested NSSAI and the subscribed NSSAI, the UDM 75 safely understands a missing S-NSSAI(s) that the UE 3 has not yet allowed to access. In this example, the UDM 75 provides the Prioritized list of VPLMN(s) including VPLMN(s) with missing S-NSSAI(s). In this example, the Requested NSSAI has the S-NSSAI 1 and S-NSSAI 2 while the UDM 75 holds the S-NSSAI 1, S-NSSAI 2, S-NSSAI 3 and S-NSSAI 4 as the subscribed NSSAI for the UE 3. In this case, the UDM 75 understands that S-NSSAI 3 and S-NSSAI 4 are missing S-NSSAI(s). Therefore, the UDM 75 provides a Prioritized list of VPLMN(s) for S-NSSAI 3 and S-NSSAI 4. For example, the prioritized list of VPLMN(s) includes VPLMN(s) that supports S-NSSAI 3 and S-NSSAI 4.

The UDM 75 may generate the above prioritized list of VPLMN(s) which lists VPLMN(s) in priority order.

For example, the UDM 75 may send the Nudm_UECM_Registration response message in a case where the UDM 75 receives, from the AMF 7001, the Nudm_UECM_Registration message or any existing message between UDM and AMF or a new message between UDM and AMF.

For example, the UDM 75 may send the Nudm_UECM_Registration response message in a case where the UDM 75 updates the DB related to supported network slice information in VPLMN(s).

The UDM 75 may generate the Slice Availability information (or the above prioritized list of VPLMN(s)) in a case where the UDM 75 receives the ‘Slice Availability in other VPLMN requested’ parameter in step 4, and send the Slice Availability information to the AMF 7001.

The UDM 75 may generate the Slice Availability information (or the above prioritized list of VPLMN(s)) in a case where the UDM 75 supports the network slice availability feature (e.g., the UDM 75 can generate the Slice Availability information) and the UDM 75 receives the ‘Slice Availability in other VPLMN requested’ parameter in step 4, and send the Slice Availability information to the AMF 7001. The UDM 75 may not include the Slice Availability information (or the above prioritized list of VPLMN(s)) in the Nudm_UECM_Registration response message in a case where the UDM 75 does not support the network slice availability feature (e.g., the UDM 75 cannot generate the Slice Availability information) and the UDM 75 receives the ‘Slice Availability in other VPLMN requested’ parameter in step 4.

In a case where the UDM 75 cannot find appropriate Slice Availability information (or cannot generate appropriate Slice Availability information), the UDM 75 may not include the Slice Availability information in the Nudm_UECM_Registration response message.

Generating the Slice Availability information may be performed by SoR-AF in this disclosure. For example, in a case where the UDM 75 receives the Nudm_UECM_Registration message in step 4, the UDM 75 may send, to the SoR-AF, a message (e.g., an Nsoraf_SoR_Get Request message) including the contents of the Nudm_UECM_Registration message in step 4. Then, the SoR-AF may generate the Slice Availability information based on the received information from the UDM 75, and send, to the UDM 75, a message (e.g., an Nsoraf_SoR_Get Response message) including the Slice Availability information. Then, the UDM 75 may send the received Slice Availability information to the AMF 7001. The SoR-AF may request, to the UDM 75 or other network nodes, necessary information for generating the Slice Availability information. The Slice Availability information may be expressed as information indicating a network slice which is available in other VPLMN (e.g., VPLMN 2). The Slice Availability information may be expressed as information indicating a network slice which is available in VPLMN(s) other than VPLMN 1. VPLMN 1 may be different from VPLMN 2 in this disclosure.

Step 6. The AMF 7001 sends a Registration Accept message to the UE 3 including the Slice Availability information that is received in the Nudm_UECM_Registration response message in step 5 from the UDM 75 and a ‘Slice Availability in other VPLMN supported’ parameter. The Registration Accept message may include the ‘Slice Availability in other VPLMN supported’ parameter. The ‘Slice Availability in other VPLMN supported’ parameter may be expressed as ‘Slice Availability in other VPLMN supported’ in this disclosure. The ‘Slice Availability in other VPLMN supported’ parameter may indicate that the network slice availability feature is supported. The ‘Slice Availability in other VPLMN supported’ parameter may indicate that the network slice availability feature is supported by the network (e.g., by the AMF 7001 or the UDM 75 or any other network nodes). The ‘Slice Availability in other VPLMN supported’ parameter may indicate that the network (e.g., the AMF 7001 or the UDM 75 or any other network nodes) can recognize or understand the ‘Slice Availability in other VPLMN requested’ parameter. The ‘Slice Availability in other VPLMN supported’ parameter may indicate that the network (e.g., the AMF 7001 or the UDM 75 or any other network nodes) can recognize or understand that the UE 3 requests the Slice Availability information. The ‘Slice Availability in other VPLMN supported’ parameter may indicate that the network (e.g., the AMF 7001 or the UDM 75 or any other network nodes) can recognize or understand that the UE 3 requests the Slice Availability information regarding other VPLMN(s). The ‘Slice Availability in other VPLMN supported’ parameter may indicate that the network (e.g., the AMF 7001 or the UDM 75 or any other network nodes) is configured to recognize or understand that the UE 3 requests the Slice Availability information regarding other VPLMN(s). In a case where the AMF 7001 receives the Slice Availability information from the UDM 75 in step 5, the AMF 7001 may send the Registration Accept message including the received Slice Availability information.

In a case where the AMF 7001 does not receive the Slice Availability feature support parameter from the UE 3 in the Registration Request message in step 3, the AMF 7001 does not include the Slice Availability information to the Registration Accept message.

In a case where the AMF 7001 does not receive the ‘Slice Availability in other VPLMN requested’ ‘parameter from the UE 3 in the Registration Request message in step 3, the AMF 7001 does not include the Slice Availability information to the Registration Accept message.

In a case where the AMF 7001 receives the ‘Slice Availability in other VPLMN requested’ parameter from the UE 3 in the Registration Request message in step 3, the AMF 7001 may include the Slice Availability information to the Registration Accept message.

The Registration Accept message may include at least one of Allowed NSSAI and Rejected NSSAI. For example, the AMF 7001 may send the Registration Accept message in a case where the AMF 7001 receives, from the UDM 75, the Nudm_UECM_Registration response message or any existing message between UDM and AMF or a new message between UDM and AMF.

In a case where the AMF 7001 does not receive the Slice Availability information in the Nudm_UECM_Registration response message in step 5 from the UDM 75, the AMF 7001 may include a ‘Slice Availability in other VPLMN supported’ parameter to the Registration Accept message.

For example, as mentioned above, the UDM 75 may not include the Slice Availability information (or the above prioritized list of VPLMN(s)) in the Nudm_UECM_Registration response message in a case where the UDM 75 does not support the network slice availability feature (e.g., the UDM 75 cannot generate the Slice Availability information) and the UDM 75 receives the ‘Slice Availability in other VPLMN requested’ parameter in step 4. In this case, the AMF 7001 does not receive the Slice Availability information. Then, the AMF 7001 may include the ‘Slice Availability in other VPLMN supported’ parameter to the Registration Accept message. The ‘Slice Availability in other VPLMN supported’ parameter in this case may indicate that the AMF 7001 does not receive the Slice Availability information although the AMF 7001 has sent the ‘Slice Availability in other VPLMN requested’ parameter to the UDM 75. In addition, the ‘Slice Availability in other VPLMN supported’ parameter in this case may indicate that the Slice Availability information is not available although the AMF 7001 has sent the ‘Slice Availability in other VPLMN requested’ parameter to the UDM 75.

Further, the ‘Slice Availability in other VPLMN supported’ parameter in this case may indicate that the Slice Availability information is not available. The ‘Slice Availability in other VPLMN supported’ parameter in this case may indicate to the UE 3 that the Slice Availability information is not available although the ‘Slice Availability in other VPLMN requested’ parameter is processed properly. The ‘Slice Availability in other VPLMN supported’ parameter in this case may indicate that the AMF 7001 is configured to recognize or understand that the UE 3 requests the Slice Availability.

In this case (e.g., in a case that the AMF 7001 does not receive the Slice Availability information in the Nudm_UECM_Registration response message in step 5), the Slice Availability information may not be included in the Registration Accept message.

There is a case where the AMF 7001 supports the network slice availability feature (e.g., the AMF 7001 is able to send the received Slice Availability information to the UE 3), but the AMF 7001 does not send the received Slice Availability information so as to prevent the UE 3 from moving to other VPLMN (in this case, the AMF 7001 seems to be an improper AMF or an AMF with improper behavior). In addition, there is a case where the AMF 7001 does not support the network slice availability feature. In these cases, the AMF 7001 may not (or cannot) include the Slice Availability information in the Registration Accept message. In addition, in these cases, the AMF 7001 may include the ‘Slice Availability in other VPLMN supported’ parameter in the Registration Accept message but may not (or cannot) include the Slice Availability information in the Registration Accept message. In addition, in these cases, the AMF 7001 may not include the Slice Availability information and the ‘Slice Availability in other VPLMN supported’ parameter in the Registration Accept message.

Step 7. Upon reception of the Registration Accept message from the AMF 7001, the UE 3 sends a Registration Complete message to the AMF 7001 including Rejected NSSAI, Location, and Tuned FB. The following bullets explain a detail of each parameter.
Rejected NSSAI is a list of S-NSSAI(s) that are requested by the UE 3 but rejected by the AMF 7001. For example, the Rejected NSSAI may be a list of S-NSSAI(s) which is included in the Requested NSSAI but rejected by the AMF 7001. For example, the Rejected NSSAI may be same to the Rejected NSSAI included in the Registration Accept message.
Location, Tuned FB may be the same as the ones in step 3.

Note that each S-NSSAI in the Rejected NSSAI may have an associated information such as a combination of FB, RAT type and PLMN ID. For example, each S-NSSAI in the Rejected NSSAI is associated with at least one of FB, RAT type and PLMN ID. For example, the PLMN ID may be VPLMN ID.

Step 8. Upon reception of the Registration Complete message from the UE 3, the AMF 7001 sends an Nudm_UECM_Update message to the UDM 75 including the Rejected NSSAI, Location and Tuned FB. The Rejected NSSAI, Location and Tuned FB included in the Nudm_UECM_Update message may be same as the ones received in step 7. The Nudm_UECM_Update message may include VPLMN ID indicating VPLMN which the UE 3 is registering to. For example, the VPLMN ID may be identity of the VPLMN 1 which the UE 3 is registering to. For example, the VPLMN ID indicates VPLMN 1 which the UE 3 is registering to.

Step 9. Based on information received in step 4 and step 8, the UDM 75 updates the DB related to supported network slice information in VPLMN(s). The UDM 75 stores the information, e.g., the Rejected NSSAI with corresponding VPLMN ID, RAT or FB supported by the UE 3. In one example when the UDM 75 determines that S-NSSAI(s) in the Rejected NSSAI is provided by another VPLMN 2 based on the DB in the UDM 75, then the UDM 75 may send, to the AMF 7001, an Nudm_UECM_Update Response message containing the Slice Availability information containing VPLMN 2 along with the S-NSSAI(s) as highest prioritized VPLMN.

Step 10. The UDM 75 sends an Nudm_UECM_Update Response message to the AMF 7001. When the AMF 7001 receives Slice Availability information in the Nudm_UECM_Update Response message, the AMF 7001 may send a new or existing NAS message to send the Slice Availability information to the UE 3.

For example, the UDM 75 may send the Nudm_UECM_Update Response message in a case where the UDM 75 receives, from the AMF 7001, the Nudm_UECM_Update message or any existing message between UDM and AMF or a new message between UDM and AMF.

For example, the UDM 75 may send the Nudm_UECM_Update Response message in a case where the UDM 75 updates the DB related to supported network slice information in VPLMN(s) based on information received in at least one of step 4 and step 8.

Step 11. The UE 3 examines the received Slice Availability information in the Registration Accept message in step 6, and makes a decision whether the UE 3 moves to a new VPLMN or not. For example, in a case where the received Slice Availability information indicates that VPLMN 2 supports S-NSSAI 1, S-NSSAI 2 and S-NSSAI 3 at FB 900 MHz, the UE 3 moves to a Cell 502 with FB 900 MHz in the VPLMN 2 as all active applications, APL 1, APL 2 and APL 3, in the UE 3 may have connections to associated Data Networks (DNs). In one example when a UE 3 finds in the Slice Availability information that another VPLMN 2 can provide a service to the S-NSSAI(s) in the Rejected NSSAI, the UE 3 may select the VPLMN 2 and initiate registration procedure to register for the S-NSSAI(s) which was rejected in the VPLMN 2. For example, in a case where the received Slice Availability information indicates that VPLMN 2 supports S-NSSAI 1, S-NSSAI 2 and S-NSSAI 3 at FB 900 MHz and VPLMN 2 has the highest priority among VPLMN(s) in the received Slice Availability information, the UE 3 moves to a Cell 502 with FB 900 MHz in the VPLMN 2.

In a case where the UE 3 does not receive the ‘Slice Availability in other VPLMN supported’ parameter in the Registration Accept message in step 6 (or in a case where the UE 3 does not receive the Slice Availability information in the Registration Accept message in step 6 or in a case where the UE 3 does not receive the Slice Availability information and the ‘Slice Availability in other VPLMN supported’ parameter in the Registration Accept message in step 6), the UE 3 may consider that the VPLMN does not support the network slice availability feature or the HPLMN does not support the network slice availability feature or neither the VPLMN nor the HPLMN support the network slice availability feature or the VPLMN is improper. In this case, the UE 3 may start scanning another VPLMN available and may start the PLMN selection procedure. For example, the UE 3 may find the VPLMN 2 by scanning another VPLMN, and may start the PLMN selection procedure for the VPLMN 2. For example, the UE 3 may find the VPLMN 2 by scanning another VPLMN, and may decide to move to the VPLMN 2.

In a case where the Registration Accept message in step 6 includes the ‘Slice Availability in other VPLMN supported’ parameter but no Slice Availability information, the UE 3 may recognize that while the network slice availability feature is supported by the VPLMN but not in the HPLMN. In this case, the UE 3 may start scanning another VPLMN available and may start the PLMN selection procedure. For example, the UE 3 may find the VPLMN 2 by scanning another VPLMN, and may start the PLMN selection procedure for the VPLMN 2. For example, the UE 3 may find the VPLMN 2 by scanning another VPLMN, and may decide to move to the VPLMN 2.

For example, the UE 3 may perform the PLMN selection in a case where the UE 3 does not receive at least one of the Slice Availability information and the ‘Slice Availability in other VPLMN supported’ parameter. The PLMN selection may be expressed as VPLMN selection in this disclosure.

Step 12. Once the UE 3 decided to move to the VPLMN 2, the UE 3 may listen to the Cell 502 and receive system information for making sure that S-NSSAI 1, S-NSSAI 2 and S-NSSAI 3 are supported. For example, the UE 3 may receive the system information, in order to confirm whether S-NSSAI(s) that the UE 3 wants to use are supported by the VPLMN (or cell(s) corresponding to the VPLMN) that the UE 3 selects in step 11.

Step 13. The UE 3 sends a Registration Request message to the AMF 7002 including User identity, Requested NSSAI, Provided NSSAI, Interested NSSAI, Location, Tuned FB, UE Radio Capability, Slice Availability feature support and ‘Slice Availability in other VPLMN requested’ parameters. The Registration message may include at least one of these above parameters. The AMF 7002 is located in VPLMN 2. For example, the Requested NSSAI in step 13 includes S-NSSAI 1, S-NSSAI 2 and S-NSSAI 3. For example, the Provided NSSAI in step 13 includes S-NSSAI 1, S-NSSAI 2 and S-NSSAI 3. For example, the Interested NSSAI in step 13 includes S-NSSAI 1, S-NSSAI 2 and S-NSSAI 3. The definition for at least one of User identity, Requested NSSAI, Provided NSSAI, Interested NSSAI, Location, Tuned FB, UE Radio Capability, Slice Availability feature support and ‘Slice Availability in other VPLMN requested’ parameter in step 3 may be applied to the parameters of the Registration Request message in step 13. The UE 3 may send the Registration Request message to the AMF 7002 in VPLMN 2 in a case where the UE 3 finds the VPLMN 2 by scanning another VPLMN and decides to move to the VPLMN 2 in step 11. The UE 3 may send the Registration Request message to the AMF 7002 in VPLMN 2 in a case where the UE 3 finds the VPLMN 2 by scanning another VPLMN and selects the VPLMN 2 in step 11.

Step 14. The Registration procedure continues with step 4 in section 4.2.2.2.2 of 3GPP TS 23.502 [4] with AMF 7002. In this example, the UE 3 is allowed to access to the S-NSSAI 1, S-NSSAI 2 and S-NSSAI 3 with the VPLMN 2. For example, in a case where the received Slice Availability information indicates that VPLMN 2 and VPLMN 3 support S-NSSAI 1, S-NSSAI 2 and S-NSSAI 3 at FB 900 MHz and VPLMN 2 has the highest priority and the VPLMN 3 has second priority among VPLMN(s) in the received Slice Availability information and the registration to the AMF 7002 in the VPLMN 2 is rejected, the UE 3 may move to a cell with FB 900 MHz in the VPLMN 3. In a case where the UE 3 receives a Registration Accept message from the AMF 7002 and the received Registration Accept message does not include the Slice Availability information (or includes the ‘Slice Availability in other VPLMN supported’ parameter but does not include the Slice Availability information, or does not include the ‘Slice Availability in other VPLMN supported’ parameter and the Slice Availability information), the UE 3 may start scanning another VPLMN available and may start the PLMN selection procedure in the same manner as step 11.

The Provided NSSAI may expressed as a first network slice which is available in a first network where the UE 3 is located. The Interested NSSAI may be expressed as a second network slice which is required by a service or an application activated in the UE 3 and is not available on the first network where the UE 3 is located. The Slice Availability information may be expressed as information indicating a second network where the second network slice is available.

### Variant 1 of First Example of the First Aspect

In a case where the UE 3 sends the Registration Request message including the ‘Slice Availability in other VPLMN requested’ parameter in step 3 but the UE 3 does not receive the ‘Slice Availability in other VPLMN supported’ parameter in the Registration Accept message in step 6 (or in a case where UE 3 sends the Registration Request message including the ‘Slice Availability in other VPLMN requested’ parameter in step 3 but the UE 3 does not receive at least one of the Slice Availability information and the ‘Slice Availability in other VPLMN supported’ parameter in the Registration Accept message in step 6), the UE 3 may construct an SMS message with (or by using or based on) at least one of VPLMN information (e.g., information indicating or related to VPLMN 1), AMF information (e.g., information indicating or related to AMF 7001), location (e.g., a UE 3's current location), date (e.g., current date) and time (e.g., current time). Then, the UE 3 may send the SMS message to a predefined O&M center in the HPLMN for indicating that the Slice Availability feature does not work with the condition as expressed by associated parameters in the SMS message. With this action, the HPLMN can check a reason why the Slice Availability feature with the VPLMN does not work and may take necessary actions.

### Variant 2 Of First Example of the First Aspect

In a case where the UE 3 sends the Registration Request message including the ‘Slice Availability in other VPLMN requested’ parameter in step 3 but the UE 3 does not receive the ‘Slice Availability in other VPLMN supported’ parameter in the Registration Accept message in step 6 (or in a case where UE 3 sends the Registration Request message including the ‘Slice Availability in other VPLMN requested’ parameter in step 3 but the UE 3 does not receive at least one of the Slice Availability information and the ‘Slice Availability in other VPLMN supported’ parameter in the Registration Accept message in step 6), the UE 3 may construct an unstructured data with (or by using or based on) at least one of VPLMN information, AMF information, location, date and time. Then, the UE 3 may initiate the NEF Anchored Mobile Originated Data Transport procedure as described in the section 4.25.4 in 3GPP TS 23.502 [4] to the AF that is located in the HPLMN. With this action, the HPLMN can check a reason why the Slice Availability feature with the VPLMN does not work and may take necessary actions. The definition for at least one of VPLMN information, AMF information, location, date and time in Variant 1 of First example of the First Aspect may be applied to this Variant 2.

### Variant 3 of First Example of the First Aspect

In another example where the UE 3 goes into roaming and the network slice support information (e.g., the list of supported S-NSSAI(s)) is not broadcast, i.e. the network slice support information is not available, the UE 3 registers to a VPLMN as per the SoR requirement (i.e., with no knowledge which VPLMN what network slices support) and the UE 3 indicates in the Registration Request message its support for network slice availability feature as per step 3 of FIG. 1. If the UE 3 does not receive the ‘Slice Availability in other VPLMN supported’ parameter from the network (e.g., the AMF 7001) in the Registration Accept message in step 6 of FIG. 1 (or if the UE 3 does not receive the Slice Availability information from the network or if the UE 3 does not receive the Slice Availability information and the ‘Slice Availability in other VPLMN supported’ parameter from the network), then the UE 3 may request Slice Availability information for other VPLMN(s) by including the ‘Slice Availability in other VPLMN requested’ parameter in the Registration Complete message in step 7. In this case the network (e.g., the AMF 7001 or another AMF or any other network nodes) may deliver at least one of the Slice Availability information and the ‘Slice Availability in other VPLMN supported’ parameter to the UE 3 by a UE Configuration Update message sent from the network (e.g., the AMF 7001 or another AMF or any other network nodes) to the UE 3 after the Registration Complete message in step 7 in FIG. 1. The UE 3 selects a new VPLMN which supports the network slice required by the UE 3 based on at least one of the Slice Availability information and the ‘Slice Availability in other PLMN supported’ parameter received from the network (e.g., the AMF 7001 or another AMF or any other network nodes) and the UE 3 registers with the selected VPLMN for the network slice required by UE 3.

### Variant 4 of First Example of the First Aspect

In another example where the UE 3 has indicated its support for the Slice Availability feature and the UE 3 has included the ‘Slice Availability in other VPLMN requested’ parameter in the Registration Request message as per step 3 in FIG. 1, the network (e.g., the AMF 7001) may provide at least one of the Slice Availability information and the ‘Slice Availability in other VPLMN support’ parameter to the UE 3 via a UE Policy update procedure. In this case the UDM 75 of the HPLMN retrieves at least one of the Slice Availability information and the ‘Slice Availability in other PLMN supported’ parameter from the DB within the UDM 75 or from a SoR node (e.g., SoR-AF) which may be part of the UDM 75 or may reside outside of the UDM 75 (or the UDM 75 may generate the Slice Availability information in the same manner as step 5). The UDM 75 provides at least one of the Slice Availability information and the ‘Slice Availability in other PLMN supported’ parameter to the PCF 7301. Then, the PCF 7301 creates a new rule, for example called ‘VPLMN selection in roaming’ rule or any other notation for a rule defining a list of PLMN(s) (e.g., VPLMN(s)) with a list of network slice(s) supported by each PLMN (e.g., each VPLMN). The new rule may include the Slice Availability information. This newly defined ‘VPLMN selection in roaming’ rule may also contain location information, i.e., the location where a network slice is supported defined in terms of TAI or Cell ID and also the times at which the network slice is supported, if the network slice is supported temporarily. This ‘VPLMN selection in roaming’ rule may be part of the URSP rules. As soon as the URSP rules are updated with the ‘VPLMN selection in roaming’ rules, the updated URSP rules, including the ‘VPLMN selection in roaming’ rule is delivered to the UE 3 via the UE Policy Update procedure within the UE Configuration Update message from the AMF 7001 to the UE 3.

Alternatively, the PCF 7301 may define new AM policy based on at least one of the Slice Availability information and the ‘Slice Availability in other PLMN supported’ parameter received from the UDM 75. In this case the new AM Policy for VPLMN selection in roaming is provided to the AMF 7001 in the VPLMN 1 and delivered to the UE 3 via the UE Configuration Update message or during the UE registration with the network.

Then, the UE 3 selects a new VPLMN which supports the network slice required by the UE 3 based on the ‘VPLMN selection in roaming’ rules within the URSP or based on the newly updated AM policy in the UE 3, and the UE 3 registers with the selected VPLMN for the network slice required by UE 3.

### Variant 5 of First Example of the First Aspect

Contents of the Registration Request message in step 3 or step 13 may be included in an uplink SoR container. Contents of the Registration Request message in step 3 or step 13 may be expressed as SOR Assistance information. The SoR container may be included in the Registration Request message in step 3 or step 13. That is, the SoR Assistance information may be included in the uplink SoR container, and the uplink SoR container may be included in the Registration Request message in step 3 or step 13.

In one example, whenever the UE 3 sends the SoR Assistance information in the uplink SoR container, the UE 3 may include an ACK Required indicator in the uplink SoR container. After sending the uplink SoR container, the UE 3 waits for an acknowledgment (e.g., at least one of the Slice Availability information and the ‘Slice Availability in other VPLMN supported’ parameter) from the HPLMN, e.g., from the UDM 75 or the SoR-AF (e.g., from the UDM 75 or the SoR-AF via an AMF in a VPLMN). The UE 3 may start a timer T. The UE 3 may start the timer T after sending the SoR Assistance information. In a case where the HPLMN (e.g., the UDM or the SoR-AF) receives the uplink SoR container with the Ack Required indicator, the HPLMN sends a downlink SoR container containing an ACK indicator. In a case where the UE 3 receives the downlink SoR container with the ACK indicator, the UE 3 determines that the HPLMN has received the uplink SoR container. The downlink SoR container may be included in the Registration Accept message, any existing downlink NAS message or a new NAS message which is sent to the UE 3. The downlink SoR container may include at least one of the Slice Availability information and the ‘Slice Availability in other VPLMN supported’ parameter.

In one example, if the HPLMN needs to send the Slice Availability information, then HPLMN may not send the ACK indicator and the HPLMN may send the Slice Availability information in the downlink SoR container. In a case where the UE 3 receives the Slice Availability information in the downlink SoR container, the UE 3 determines that the HPLMN has received the uplink SoR container.

The SoR Assistance information may include at least one of the followings:
User identity
Requested NSSAI
Provided NSSAI
Interested NSSAI
Location
Tuned FB
UE Radio Capability
Slice Availability feature support

If the UE 3 doesn't receive the downlink SoR container containing the ACK indicator or not any downlink SoR container in the Registration Accept message or any existing downlink NAS message or a new NAS message, the UE 3 determines that the uplink SoR container is not received by the HPLMN because the VPLMN may not have sent the uplink NAS container (or the uplink SoR container) to the HPLMN. In this case, the UE 3 may deprioritize the VPLMN (e.g., the UE 3 may select VPLMN(s) other than this VPLMN in a case where the UE 3 performs the PLMN selection). The UE 3 may perform the PLMN selection procedure to find and register to another VPLMN. If the another PLMN is not available at current location, the UE 3 may still register the current VPLMN. In one example the UE 3 may not consider the current VPLMN for the PLMN selection for a certain time (e.g., in seconds, minute or hours). E.g., the UE 3 may not consider the current VPLMN for 5 minutes. In one example, in a case where the timer T expires, the UE 3 retransmits the uplink SoR container to the HPLMN. If the UE 3 retransmits the uplink SoR container for n number of times (n may be an integer greater than or equal to 0 or 1) but the UE 3 doesn't receive any downlink SoR container or downlink SoR container with the ACK indicator, the UE 3 may select another PLMN (or another VPLMN). The UE 3 further applies the procedure as defined in above in this Aspects in this disclosure. For example, in a case where the UE 3 selects another PLMN (or another VPLMN), the UE 3 may perform the process in step 11 of the FIG. 1.

The existence of the SoR Assistance information in the Registration Request message in step 3 may imply to the AMF 7001 that the Slice Availability in other VPLMN is requested by the UE 3. For example, inclusion of the SoR Assistance information (or inclusion of contents of the SoR Assistance information) may serve same function of (or may play same role for) inclusion of the ‘Slice Availability in other VPLMN requested’ parameter.

For example, the UE 3 may include the SoR Assistance information in the Registration Request message in step 3 instead of including the ‘Slice Availability in other VPLMN requested’ parameter. For example, in a case where the UE 3 does not receive the ‘Slice Availability in other VPLMN supported’ parameter in the Registration Accept message (or in a case where the UE 3 does not receive the Slice Availability information in the Registration Accept message in step 6 or in a case where the UE 3 does not receive the Slice Availability information and the ‘Slice Availability in other VPLMN supported’ parameter in the Registration Accept message in step 6) after sending the Registration Request message which includes the SoR Assistance information (or which includes the contents of the SoR Assistance information), the UE 3 may consider that the VPLMN does not support the network slice availability feature or the HPLMN does not support the network slice availability feature or neither the VPLMN nor the HPLMN support the network slice availability feature or the VPLMN is improper. Then the UE 3 may start scanning another VPLMN available and may start the PLMN selection procedure as mentioned in step 11. As described, the SoR Assistance information may be used instead of the ‘Slice Availability in other VPLMN requested’ parameter. How to use inclusion of the SoR Assistance information may be same in the First example of the First Aspect. For example, the UE 3 may include the SoR Assistance information in the Registration Request message in step 3 or step 13 instead of including the ‘Slice Availability in other VPLMN requested’ parameter, and the UE 3 and the network (e.g., the AMF 7001, the AMF 7002, the UDM 75 and other network nodes and so on) may perform the same processes mentioned in the First example of the First Aspect.

The existence of the uplink SoR container in the Registration Request message in step 3 may imply to the AMF 7001 that the Slice Availability in other VPLMN is requested by the UE 3. For example, inclusion of the uplink SoR container (or inclusion of contents of the uplink SoR container) may serve same function of (or may play same role for) inclusion of the ‘Slice Availability in other VPLMN requested’ parameter.

For example, the UE 3 may include the uplink SoR container in the Registration Request message in step 3 instead of including the ‘Slice Availability in other VPLMN requested’ parameter. For example, in a case where the UE 3 does not receive the ‘Slice Availability in other VPLMN supported’ parameter in the Registration Accept message (or in a case where the UE 3 does not receive the Slice Availability information in the Registration Accept message in step 6 or in a case where the UE 3 does not receive the Slice Availability information and the ‘Slice Availability in other VPLMN supported’ parameter in the Registration Accept message in step 6) after sending the Registration Request message which includes the uplink SoR container (or which includes the contents of the uplink SoR container), the UE 3 may consider that the VPLMN does not support the network slice availability feature or the HPLMN does not support the network slice availability feature or neither the VPLMN nor the HPLMN support the network slice availability feature or the VPLMN is improper. Then the UE 3 may start scanning another VPLMN available and may start the PLMN selection procedure as mentioned in step 11. As described, the uplink SoR container may be used instead of the ‘Slice Availability in other VPLMN requested’ parameter. How to use inclusion of the uplink SoR container may be same in the First example of the First Aspect. For example, the UE 3 may include the uplink SoR container in the Registration Request message in step 3 or step 13 instead of including the ‘Slice Availability in other VPLMN requested’ parameter, and the UE 3 and the network (e.g., the AMF 7001, the AMF 7002, the UDM 75 and other network nodes and so on) may perform the same processes mentioned in the First example of the First Aspect.

In one example, whenever the UE 3 sends the uplink SoR container, the UE 3 waits for the downlink SoR container. If the downlink SoR container is not received then the UE 3 determines that the uplink SoR container is not received by the HPLMN (e.g., because the VPLMN may not have sent the uplink NAS container (or the uplink SoR container) to the HPLMN), and the UE 3 may select another VPLMN as defined in the First example of the First Aspect or this variant. If a NF (e.g., the UDM 75 or SoR-AF) receives the uplink SoR container, the NF may send the downlink SoR container. The downlink SoR container may contain the Slice Availability information or the downlink SoR container can be empty.

### Variant 6 of First Example of the First Aspect

In one example, the message in step 3 can be any existing NAS message (e.g., an UPLINK NAS Transport message) or a new NAS message. In addition, in step 6, the Registration Accept message can be any existing NAS message (e.g., a downlink NAS transport message) or a new NAS message.

According to the First example of the First Aspect and the variants of the First example, it can solve the above-mentioned problem. For example, the First example of the First Aspect and the variants of the First example can solve the problem that the outbound roamers may not get service(s) that are only available with a network slice but that network slice is not available in the VPLMN while such network slice are available in another VPLMN(s).

For example, the First example of the First Aspect and the variants of the First example can solve the problem that a serious inconvenience to users as requested services may not be available while the user is roaming.

For example, according to the First example of the First Aspect and the variants of the First example, in a case where the UE 3 does not receive at least one of the Slice Availability information and the ‘Slice Availability in other VPLMN supported’ parameter, the UE 3 determines that at least one of the current VPLMN (e.g., the VPLMN which is selected by the UE 3 currently) and the HPLMN does not support the network slice availability feature or that the VPLMN is improper, and the UE 3 performs the PLMN selection. For example, this process can increase possibility that the UE 3 can obtain at least one of the Slice Availability information and the ‘Slice Availability in other VPLMN supported’ parameter in other selected VPLMN. Therefore, it can solve the above-mentioned problem.

### Variant 7 of First Example of the First Aspect

In step 11, in a case where the UE 3 receives the Rejected NSSAI in the Registration Accept message in step 6 but the UE 3 does not receive the ‘Slice Availability in other VPLMN supported’ parameter in the Registration Accept message in step 6 (or in a case where the UE 3 does not receive the Slice Availability information in the Registration Accept message in step 6 or in a case where the UE 3 does not receive the Slice Availability information and the ‘Slice Availability in other VPLMN supported’ parameter in the Registration Accept message in step 6), the UE 3 may start scanning another VPLMN available and may start the PLMN selection procedure.

### Second Example of the First Aspect

Second example of the First Aspect discloses a method where the UE 3 uses non-3GPP access for the Slice Availability feature.

In order to make the Second example of the First Aspect understandable, the Second example of the First Aspect takes the same examples with the First example of the First Aspect. For example, the Second example of the First Aspect may take the same examples with the First example of the First Aspect as shown below.

### For the UE 3:

The UE 3 has four applications installed, APL 1, APL 2, APL 3 and APL 4 and these applications are associated with network slice S-NSSAI 1, S-NSSAI 2, S-NSSAI 3 and S-NSSAI 4 respectively based on the URSP rule in the UE 3. For example, these applications may be associate with a network slice identified by S-NSSAI 1, a network slice identified by S-NSSAI 2, a network slice identified by S-NSSAI 3 and a network slice identified by S-NSSAI 4 respectively.

The UE 3 has three applications APL 1, APL 2 and APL 3 active when the UE 3 initiates a Registration Procedure to the VPLMN 1. I.E, the UE 3 is interested in network slices S-NSSAI 1, S-NSSAI 2 and S-NSSAI 3 to be allowed to access by the VPLMN 1. The application(s) may be expressed as service(s). The application(s) may correspond service(s). For example, the UE 3 may activate APL 1, require Service 1 corresponding to APL 1 and perform a registration procedure corresponding to S-NSSAI 1.

### For VPLMN 1:

A Cell 501 supports network slices, S-NSSAI 1 and S-NSSAI 2.

### For HPLMN of the UE 3:

A UDM 75 has a subscriber data for the UE 3 including S-NSSAI 1, S-NSSAI 2, S-NSSAI 3 and S-NSSAI 4 in the subscribed NSSAI for the UE 3.

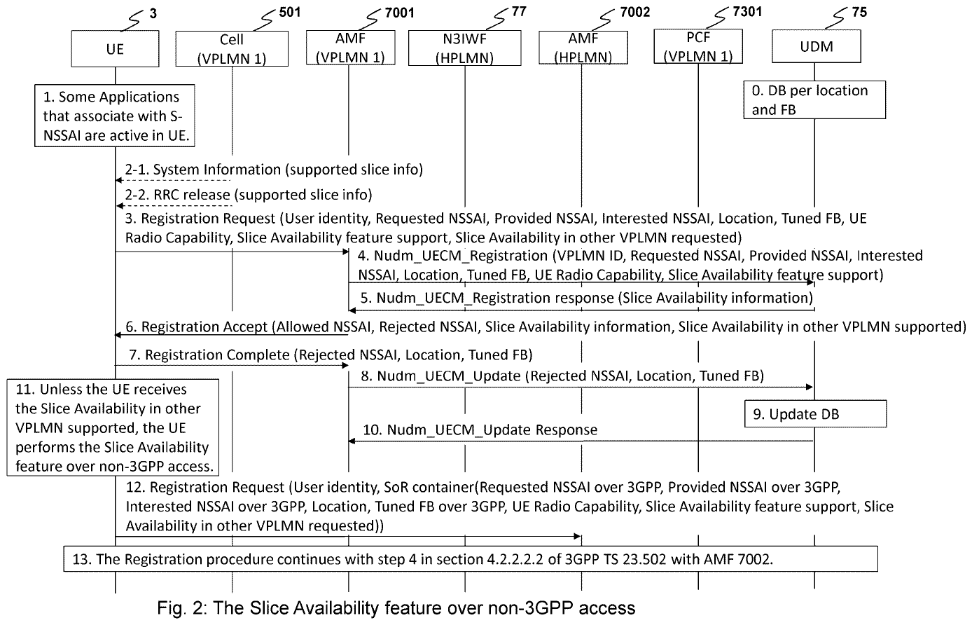

The detailed processes of the Second example of the First Aspect are as described below, with reference to FIG. 2.

Steps 0-10. These steps are the same as the steps 0 to 10 in the First example of the First Aspect.

Step 11. In a case where the UE 3 does not receive the ‘Slice Availability in other VPLMN supported’ parameter in the Registration Accept message in step 6 (or in a case where the UE 3 does not receive the Slice Availability information in the Registration Accept message in step 6 or in a case where the UE 3 does not receive the Slice Availability information and the ‘Slice Availability in other VPLMN supported’ parameter in the Registration Accept message in step 6), the UE 3 may consider that the VPLMN (e.g., VPLMN 1) does not support the network slice availability feature. In this case, the UE 3 may initiate the Registration procedure over the non-3GPP access to perform the Slice Availability feature using the non-3GPP access.

Once the UE 3 decided to initiate the Registration procedure over the non-3GPP access, the UE 3 discovers an N3IWF 77 that is located in the HPLMN based on a knowledge that an associated AMF 7002 with the N3IWF 77 in the HPLMN surely supports the Slice Availability feature. The knowledge may be configured to the UE 3 or the UE 3 may receive the knowledge from the network (e.g., an AMF or any other network nodes). The AMF 7002 may be located in the HPLMN.

Step 12. The UE 3 sends a Registration Request message over the non-3GPP access to an AMF 7002. The Registration Request message may include User identity, SoR container, Requested NSSAI, Provided NSSAI, Interested NSSAI, Location, Tuned FB, UE Radio Capability, Slice Availability feature support and ‘Slice Availability in other VPLMN requested’ parameters. The UE 3 may perform a Registration Procedure over the non-3GPP access by sending the Registration Request message. The definition for at least one of User identity, Requested NSSAI, Provided NSSAI, Interested NSSAI, Location, Tuned FB, UE Radio Capability, Slice Availability feature support and ‘Slice Availability in other VPLMN requested’ parameter in step 3 may be applied to the parameters of the Registration Request message in step 12.

The SoR container may include User identity, Requested NSSAI over 3GPP access, Provided NSSAI over 3GPP access, Interested NSSAI over 3GPP access, Location over 3GPP access, Tuned FB over 3GPP access, UE Radio Capability, Slice Availability feature support and ‘Slice Availability in other VPLMN requested’ parameters. The following bullets explain a detail of each parameter in the SoR container.
User Identity may be a 5G-GUTI, SUCI or SUPI. For example, the User Identity may be a 5G-GUTI, SUCI or SUPI for the UE 3.
Requested NSSAI over 3GPP access includes a list of S-NSSAI(s) that the UE 3 wishes to request to the VPLMN 1 over 3GPP access. In this example, the UE 3 populates S-NSSAI 1 and S-NSSAI 2 to the Requested NSSAI over 3GPP access as the UE 3 knows, based on step 2-1 or step 2-2, that S-NSSAI 1 and S-NSSAI 2 are the network slices available in the Cell 501. I.E., although the UE 3 also wishes to request S-NSSAI 3 because an associated APL 3 is active in the UE 3, the UE 3 does not request the S-NSSAI 3 as it is unlikely to be accepted by the AMF 7001 due to no support of the S-NSSAI 3 by the Cell 501. In this example, the Requested NSSAI over 3GPP access includes S-NSSAI 1 and S-NSSAI 2.
Provided NSSAI over 3GPP access may include a list of S-NSSAI(s) that are available in a cell of the VPLMN 1 over 3GPP access where the UE 3 is camped on. In this example, the UE 3 may populate S-NSSAI 1 and S-NSSAI 2 based on information received in step 2-1 and step 2-2. In this example, the Provided NSSAI over 3GPP access includes S-NSSAI 1 and S-NSSAI 2.

In one example, each S-NSSAI in the Provided NSSAI over 3GPP access may have an associated information such as a list of FB(s) on which the S-NSSAI is available or deployed in the VPLMN 1. The UE 3 may obtain the Provided NSSAI over 3GPP access in each FB by listening to a system information over each FB that the VPLMN 1 provides. The Provided NSSAI over 3GPP access may be expressed as available S-NSSAI(s) over 3GPP access. For example, the UE 3 may associate the FB which the system information is broadcasted with the Provided NSSAI over 3GPP access.

In another example, each S-NSSAI in the Provided NSSAI over 3GPP access may have an associated information such as a list of FB(s) together with RAT type.

In another example, each S-NSSAI in the Provided NSSAI over 3GPP access may have an associated information such as a list of FB(s) together with VPLMN ID that S-NSSAI is available in another VPLMN(s). The UE 3 may obtain available S-NSSAI(s) in FB in each VPLMN by listening a system information over each FB in each VPLMN.

Note that each S-NSSAI in the Provided NSSAI over 3GPP access may have an associated information such as a combination of FB, RAT type and PLMN ID. For example, each S-NSSAI in the Provided NSSAI over 3GPP access is associated with at least one of FB, RAT type and PLMN ID. The PLMN ID may be VPLMN ID.
Interested NSSAI over 3GPP access may include a list of S-NSSAI(s) that UE 3 is interested in over 3GPP access. In this example, the UE 3 may populate S-NSSAI 1, S-NSSAI 2 and S-NSSAI 3 as APL 1, APL 2 and APL 3 are active in the UE 3. For example, the Interested NSSAI over 3GPP access may include S-NSSAI 1, S-NSSAI 2 and S-NSSAI 3. In one example the Interested NSSAI over 3GPP access includes the S-NSSAI which the UE 3 wants to register to the VPLMN 1 but the S-NSSAI is not provided by the cell which the UE 3 is camped on. For example, the Interested NSSAI over 3GPP access may include S-NSSAI 3.
Location over 3GPP access may be a location of the UE 3. Location over 3GPP access can be a geographical location of the UE 3. For example, Location over 3GPP access can be a Tracking Area Identity (TAI), NR Cell Global Identity (NCGI) as defined in the 3GPP TS 23.003 [7], NR Cell Identity (NCI) as defined in the 3GPP TS 23.003 [7], E-UTRAN Cell Global Identifier (ECGI) as defined in the 3GPP TS 23.003 [7], Global Cable Identifier (GCI) as defined in the 3GPP TS 23.003 [7], a general City name, zip-code, formed with GPS location or a location expressed with civic and geospatial location formats as defined in IETF RFC 5580 [9].
Tuned FB over 3GPP access is a Frequency Band that the UE 3 is currently tuned to. For example, Tuned FB is 800 MHz, 900 MHz or 6 GHz. For example, Tuned FB over 3GPP access may be a Frequency Band that the UE 3 tunes currently over 3GPP access.

In one example, Tuned FB over 3GPP access may have an associated information such as a RAT type.
UE Radio Capability indicates Frequency Bands that the UE 3 supports. The UE Radio Capability may also indicate a combination of Frequency Band and RAT type that UE 3 supports.
Slice Availability feature support parameter indicates that the UE 3 supports the network slice availability feature.

I.E., when the UE 3 receives a Slice Availability information from the UDM 75 via the AMF 7001, the UE 3 is able to process the Slice Availability information and select a VPLMN based on outcome of the process of the received Slice Availability information. For example, the network slice availability feature indicates that the UE 3 is able to process the Slice Availability information and select a VPLMN based on outcome of the process of the received Slice Availability information.

The Slice Availability feature support parameter may be expressed as Slice Availability feature support. The definition of the Slice Availability feature support parameter in the First example of the First Aspect may be applied to the Second example of the First Aspect.
Slice Availability in other VPLMN requested parameter indicates that the UE 3 requests the network slice availability information. The ‘Slice Availability in other VPLMN requested’ parameter may indicate that the UE 3 requests the network slice availability information regarding other VPLMN in this disclosure. The definition of the ‘Slice Availability in other VPLMN requested’ parameter in the First example of the First Aspect may be applied to the Second example of the First Aspect.

Step 13. The Registration procedure continues with step 4 in section 4.2.2.2.2 of 3GPP TS 23.502 [4] with AMF 7002 with the following additions.
When the AMF 7002 receives the Registration Request message from the UE 3 in step 12, the AMF 7002 sends an Nudm_UECM_Registration message to the UDM 75 including SoR container among with existing parameters.
When the UDM 75 receives the Nudm_UECM_Registration message from the AMF 7002 including the SoR container, the UDM 75 decomposes the SoR container and extracts the parameter as listed in the step 4 in the First example of the First Aspect. Then, the UDM 75 may perform a process in the same manner as step 5 in the First example of the First Aspect. For example, the UDM 75 may generate the Slice Availability information and send the Slice Availability information to the AMF 7002 (e.g., the UDM 75 may generate the Slice Availability information suitable for the 3GPP access based on the above mentioned received parameters regarding the 3GPP access). Then, the AMF 7002 may send the Slice Availability information to the UE3 or may perform same processes in step 6 of the First example of the First Aspect.

### Variant 1 of Second Example of the First Aspect

In one example, the UE 3 chooses an AMF 7002 that is located other than the HPLMN as far as the UE 3 knows that such AMF 7002 supports the network slice availability feature.

According to the Second example of the First Aspect and the variant of the Second example, it can solve the above-mentioned problem.

For example, the Second example of the First Aspect and the variant of the Second example can solve the problem that the outbound roamers may not get service(s) that are only available with a network slice but that network slice is not available in the VPLMN while such network slice are available in another VPLMN(s).

For example, the Second example of the First Aspect and the variant of the Second example can solve the problem that a serious inconvenience to users as requested services may not be available while the user is roaming.

For example, according to the Second example of the First Aspect and the variant of the Second example, in a case where the UE 3 does not receive at least one of the Slice Availability information and the ‘Slice Availability in other VPLMN supported’ parameter, the UE 3 determines that the current VPLMN (e.g., the VPLMN which is selected by the UE 3 currently) does not support the network slice availability feature or that the VPLMN is improper, and the UE 3 performs the Registration procedure over the non-3GPP access. For example, this process can increase possibility that the UE 3 can obtain at least one of the Slice Availability information and the ‘Slice Availability in other VPLMN supported’ parameter in HPLMN. Therefore, it can solve the above-mentioned problem.

The processes in the First example of the First Aspect may be applied to the Second example of the First Aspect and the variant of the Second example of the First Aspect. The Variants in the First example of the First Aspect may be applied to the Second example of the First Aspect and the variant of the Second example of the First Aspect.

### System Overview

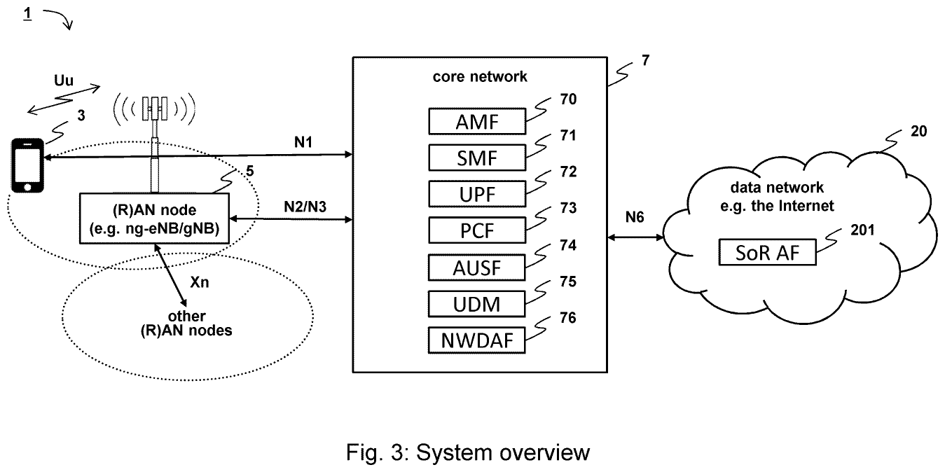

FIG. 3 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7. The data network 20 may include SoR-AF 201. The SoR-AF 201 may be included in the core network 7.

The (R)AN node 5 (e.g., (R)AN node 501, (R)AN node 502) supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in logical nodes can be considered as a network function. The network function may be provided to another node by adapting the Service Based Architecture (SBA). A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e., radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70 (e.g., AMF 7001, AMF 7002). The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73 (e.g., PCF 7301), an Authentication Server Function (AUSF) 74, a Unified Data Management (UDM) 75, and a Network Data Analytics Function (NWDAF) 76. The core network 7 may also include N3IWF 77. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPv6, IPv4v6, Ethernet or unstructured data type.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
   establishmentCause and ue-Identity. The ue-Identity may have a value of ng-5G-S-TMSI-Part1 or random Value.
RRC Setup message: This message is sent from the (R)AN node 5 to the UE 3. In addition to the parameters that are disclosed by Aspects in this disclosure, following parameters may be included together in the RRC Setup message.
   masterCellGroup and radioBearerConfig
RRC setup complete message: This message is sent from the UE 3 to the (R)AN node 5. In addition to the parameters that are disclosed by Aspects in this disclosure, following parameters may be included together in the RRC setup complete message.
   guami-Type, iab-NodeIndication, idleMeas Available, mobility State, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
registration request message: This message is sent from the UE 3 to the AMF 70. In addition to the parameters that are disclosed by Aspects in this disclosure, following parameters may be included together in the registration request message.
   5GS registration type, ngKSI, 5GS mobile identity, Non-current native NAS key set identifier, 5GMM capability, UE security capability, Requested NSSAI, Last visited registered TAI, S1 UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
registration accept message: This message is sent from the AMF 70 to the UE 3. In addition to the parameters that are disclosed by Aspects in this disclosure, following parameters may be included together in the registration accept message.
   5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
   SOR transparent container.
Authentication Request message: This message is sent from the AMF 70 to the UE 3. In addition to the parameters that are disclosed by Aspects in this disclosure, following parameters may be included together in the Authentication Request message.
   ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message.
   Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
   ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.
   Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
   EAP message.
Service Request message: This message is sent from the UE 3 to the AMF 70. In addition to the parameters that are disclosed by Aspects in this disclosure, following parameters may be populated together in the Service Request message.
   ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
   PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
   5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
   Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
   Configuration update complete message identity.

### User Equipment (UE)

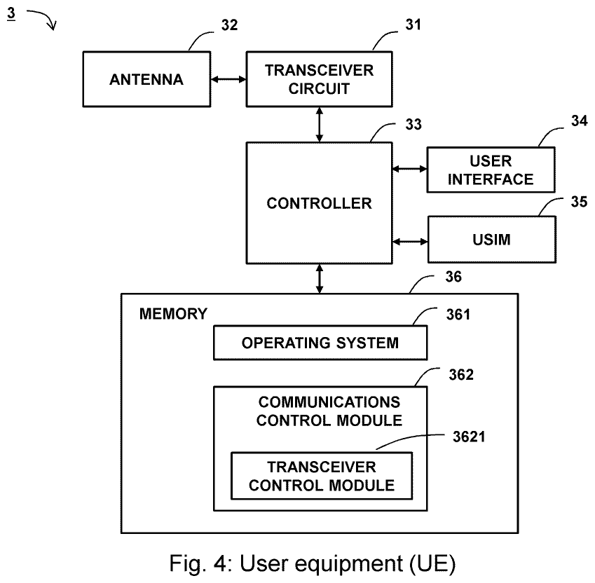

FIG. 4 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36.

The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g., a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g., vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g., smart glasses, a smart watch, a smart ring, or a hearable device). The UE 3 may be a car, or a connected car, or an autonomous car, or a vehicle device, or a motorcycle or V2X (Vehicle to Everything) communication module (e.g., Vehicle to Vehicle communication module, Vehicle to Infrastructure communication module, Vehicle to People communication module and Vehicle to Network communication module).

### (R)AN Node

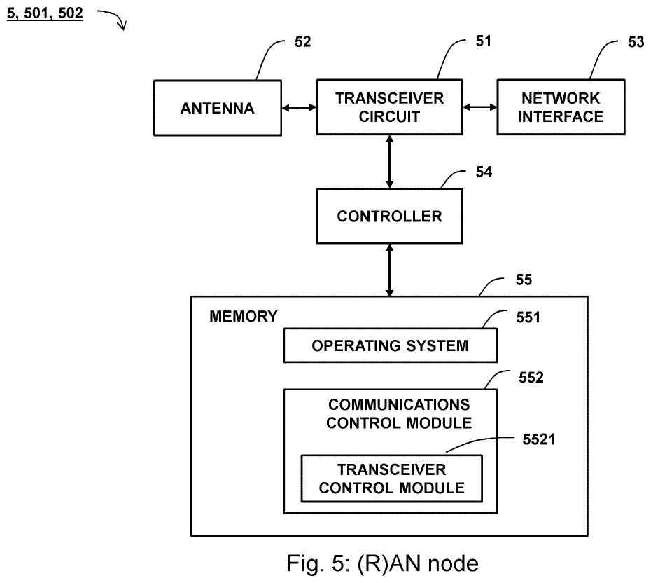

FIG. 5 is a block diagram illustrating the main components of an exemplary (R)AN node 5, for example a base station (‘eNB’ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g., directly or indirectly). The signalling may include, for example, appropriately formatted signalling messages relating to a radio connection and a connection with the core network 7 (for a particular UE 3), and in particular, relating to connection establishment and maintenance (e.g., RRC connection establishment and other RRC messages), NG Application Protocol (NGAP) messages (i.e., messages by N2 reference point) and Xn application protocol (XnAP) messages (i.e., messages by Xn reference point), etc. Such signalling may also include, for example, broadcast information (e.g., Master Information and System information) in a sending case. The controller 54 is also configured (by software or hardware) to handle related tasks such as, when implemented, UE mobility estimate and/or moving trajectory estimation.

The (R)AN node 5 may support the Non-Public Network (NPN), The NPN may be a Stand-alone Non-Public Network (SNPN) or a Public Network Integrated NPN (PNI-NPN). The Cell 501 (e.g., (R)AN node which controls the Cell 501) and The Cell 502 (e.g., (R)AN node which controls the Cell 502) may have same components to the (R)AN node 5.

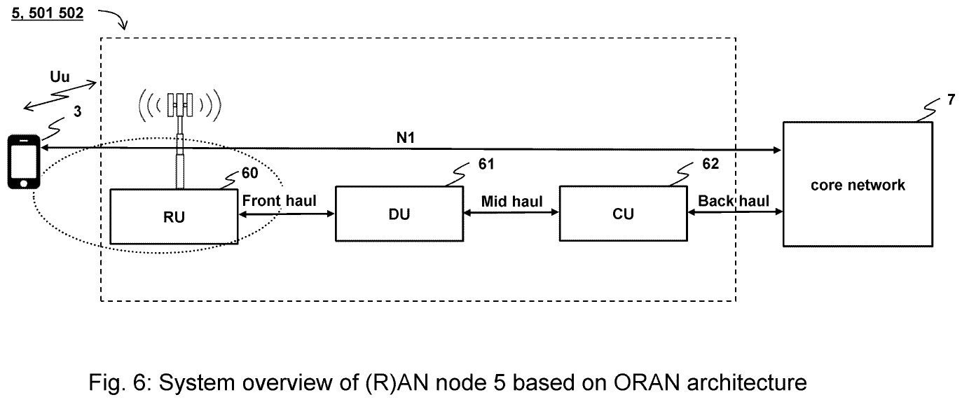

System overview of (R)AN node 5 based on O-RAN architecture FIG. 6 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g., one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide functionalities to communicate with a UE 3 over air interface, the DU 61 may provide functionalities to support MAC layer and RLC layer, the CU 62 may provide functionalities to support PDCP layer, SDAP layer and RRC layer.

### Radio Unit (RU)

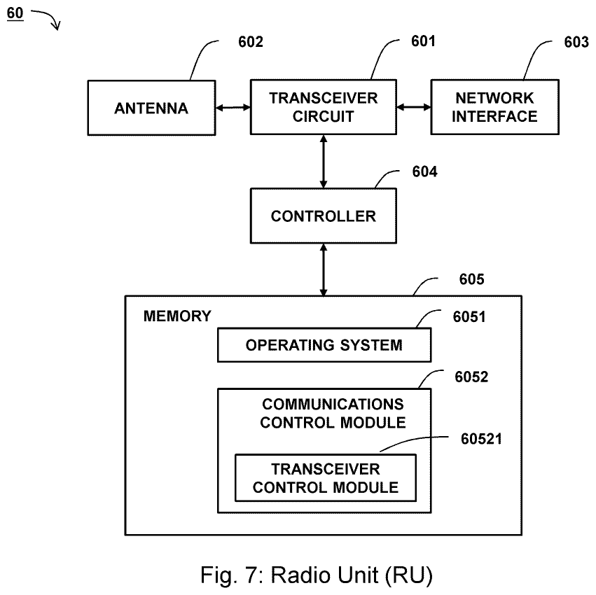

FIG. 7 is a block diagram illustrating the main components of an exemplary RU 60, for example a RU part of base station (‘eNB’ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g., directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### Distributed Unit (DU)

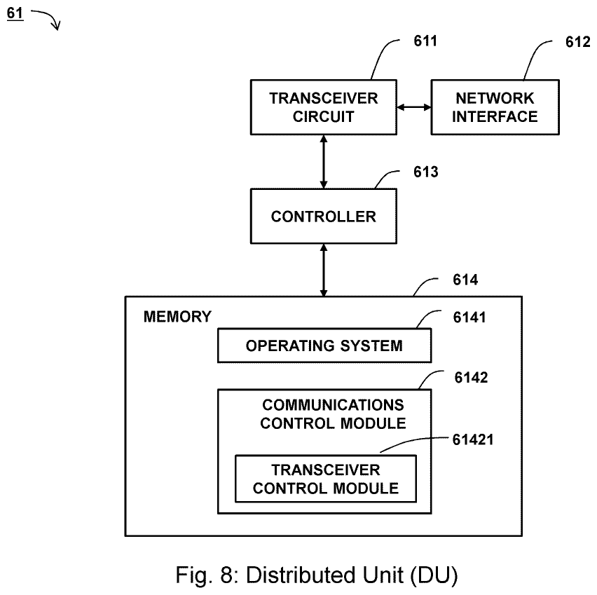

FIG. 8 is a block diagram illustrating the main components of an exemplary DU 61, for example a DU part of a base station (‘eNB’ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### Centralized Unit (CU)

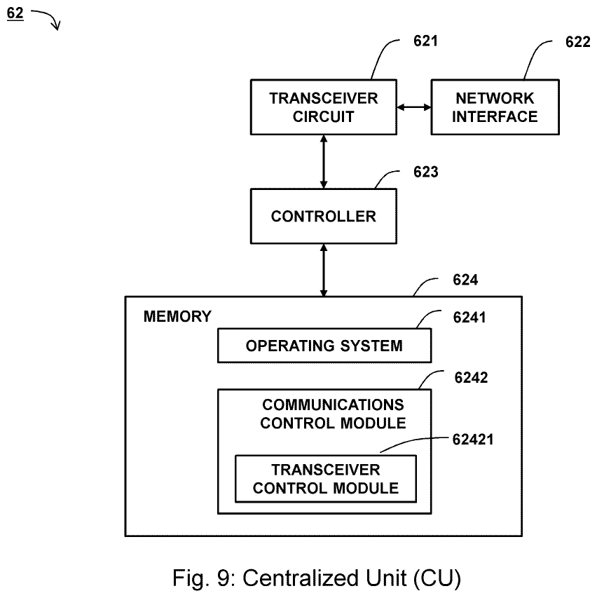

FIG. 9 is a block diagram illustrating the main components of an exemplary CU 62, for example a CU part of base station (‘eNB’ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### AMF

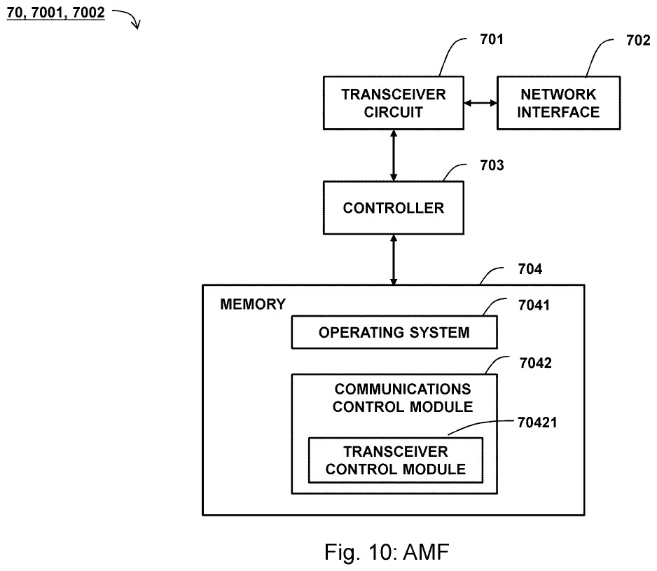

FIG. 10 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g., via the (R)AN node 5) and other core network nodes (including core network nodes in the HPLMN of the UE 3 when the UE 3 is roaming-in. Such signalling may include, for example, appropriately formatted signalling messages (e.g., a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN). The AMF 7001 and the AMF 7002 may have same components to the AMF 70.

### PCF

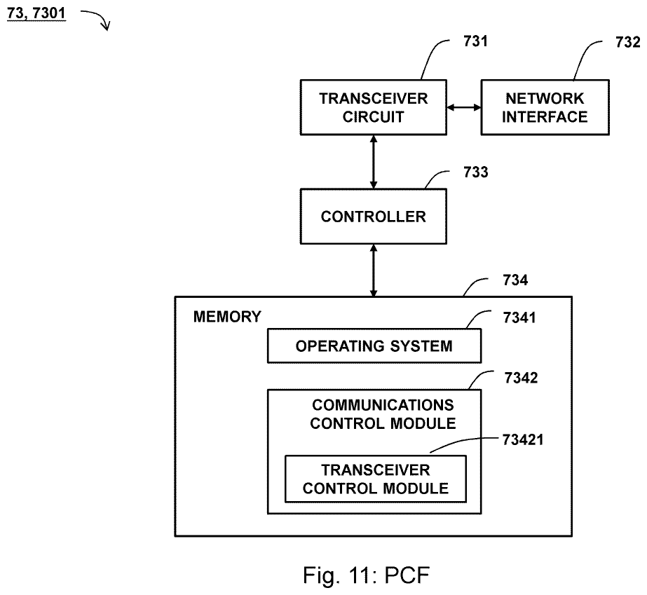

FIG. 11 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g., a removable memory device (RMD)), for example. The software includes, among other things, an operating system 7341 and a communications control module 7342 having at least a transceiver control module 73421. The communications control module 7342 using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in). Such signalling may include, for example, appropriately formatted signalling messages (e.g., a HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN). The PCF 7301 may have same components to the PCF 73.

### AUSF

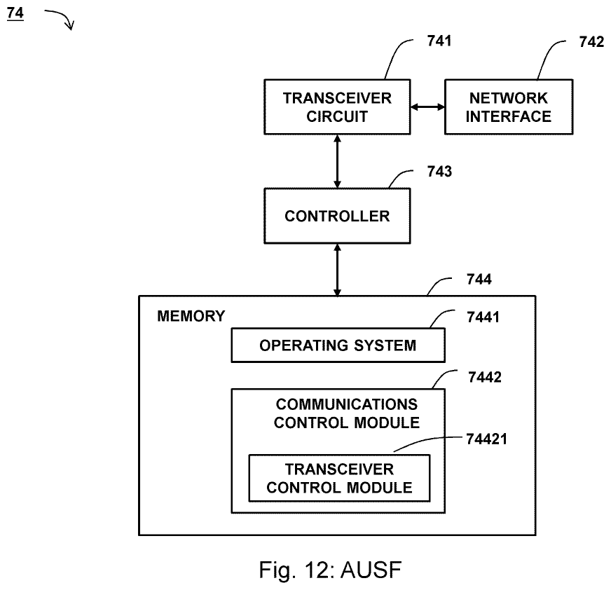

FIG. 12 is a block diagram illustrating the main components of the AUSF 74. As shown, the apparatus includes a transceiver circuit 741 which is operable to transmit signals to and to receive signals from other nodes (including the UDM 75) via a network interface 742. A controller 743 controls the operation of the AUSF 74 in accordance with software stored in a memory 744. Software may be pre-installed in the memory 744 and/or may be downloaded via the telecommunication network or from a removable data storage device (e.g., a removable memory device (RMD)), for example. The software includes, among other things, an operating system 7441 and a communications control module 7442 having at least a transceiver control module 74421. The communications control module 7442 using its transceiver control module 74421 is responsible for handling (generating/sending/receiving) signalling between the AUSF 74 and other nodes, such as the AMF 70 and other core network nodes (including core network nodes in the HPLMN of the UE 3 when the UE 3 is roaming-in). Such signalling may include, for example, appropriately formatted signalling messages (e.g., a HTTP restful methods based on the service based interfaces) relating to policy management procedures (for the UE 3). The AUSF 74 may support the Non-Public Network (NPN), The NPN may be a Stand-alone Non-Public Network (SNPN) or a Public Network Integrated NPN (PNI-NPN).

### UDM

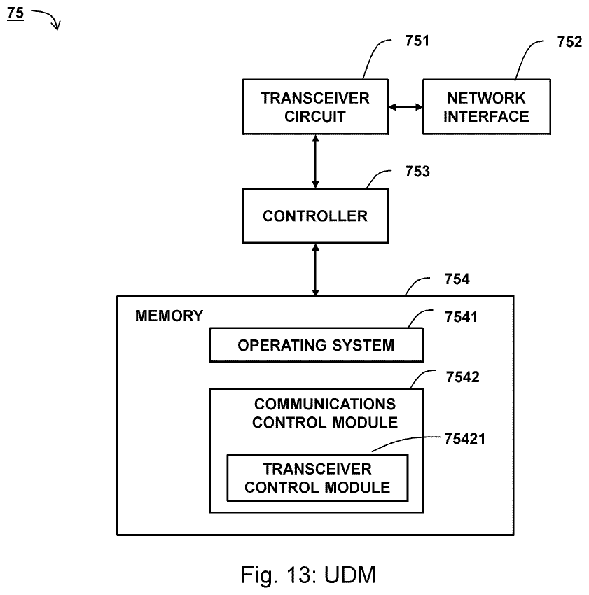

FIG. 13 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out). Such signalling may include, for example, appropriately formatted signalling messages (e.g., a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN). The SoR-AF 201 may be part of the UDM 75. The SoR-AF 201 may have same components to the UDM 75. The SoR-AF 201 may be realized by the components of the UDM 75.

### N3IWF

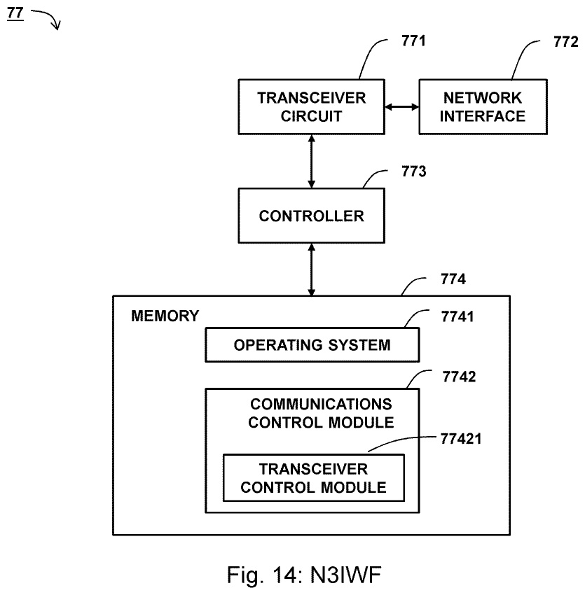

FIG. 14 is a block diagram illustrating the main components of the N3IWF 77. As shown, the apparatus includes a transceiver circuit 771 which is operable to transmit signals to and to receive signals from other nodes (including the UE 3) via a network interface 772. A controller 773 controls the operation of the N3IWF 77 in accordance with software stored in a memory 774. Software may be pre-installed in the memory 774 and/or may be downloaded via the telecommunication network or from a removable data storage device (RMD), for example. The software includes, among other things, an operating system 7741 and a communications control module 7742 having at least a transceiver control module 77421. The communications control module 7742 using its transceiver control module 77421 is responsible for handling (generating/sending/receiving) signalling between the N3IWF 77 and other nodes, such as the UE 3 and the AMF 70 and other core network nodes (including core network nodes in the HPLMN of the UE 3 when the UE 3 is roaming-in). Such signalling may include, for example, appropriately formatted signalling messages (e.g., a registration request message and associated response messages) relating to access and mobility management procedures (for the UE 3).

The N3IWF 77 may support the Non-Public Network (NPN), The NPN may be a Stand-alone Non-Public Network (SNPN) or a Public Network Integrated NPN (PNI-NPN).

The whole or part of the example Aspects disclosed above can be described as, but not limited to, the following.

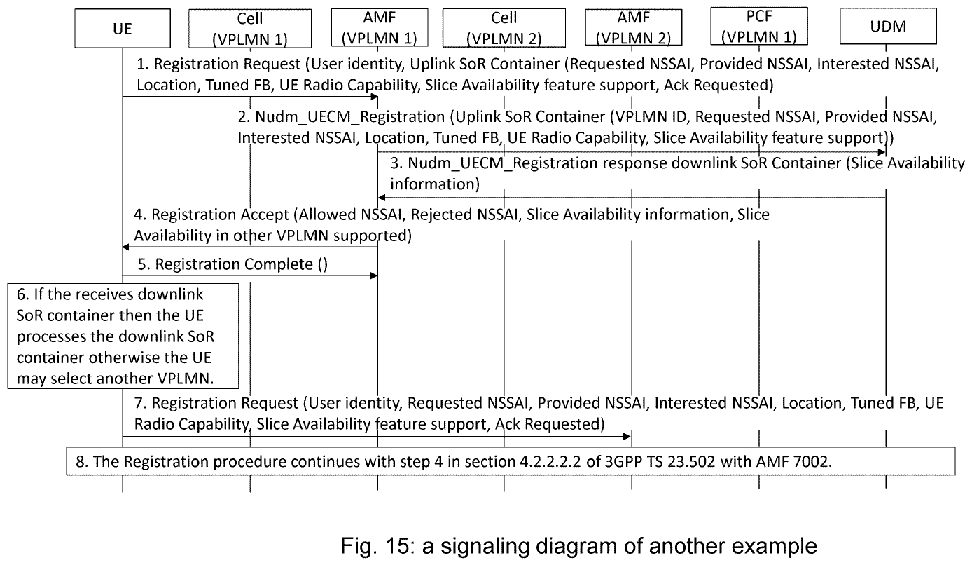

### 1. Slice Based Steering of Roaming Procedure (See FIG. 15)

1. A UE receives a trigger to register for a S-NSSAI. The UE sends Registration Request message containing requested NSSAI set to the S-NSSAI. The Registration Request message may contain a Uplink SoR Transparent container which contains assistance information for the steering of roaming and the Uplink SoR Transparent container may contain an ACK Required information.
2. When the AMF receives registration request it forwards the Uplink SoR Transparent container to the UDM in the Nudm_UECM_Registration Request message to the UDM.
3. Upon reception of the Nudm_UECM_Registration Request message, the UDM stores the Uplink SoR container or trigger the slice based SoR procedure. If the SoR-AF is not implemented in the HPLMN then the UDM sends to PLMN list in the priority order and the list of S-NSSAI supported by each PLMN (this is called slice based SoR list) to the AUSF to provide the integrity MAC header of slice based SoR list. Upon reception of the MAC header, the UDM sends the slice based SoR list to the AMF in a SoR container. If the UDM decide to not send Slice based SoR list, the UDM sends an empty SoR container containing MAC header sent by the AUSF or SoR container with an indicator Ack which is integrity protected by the AUSF.

When the SoR-AF is implemented in the HPLMN, the HPLMN sends forwards the Uplink NAS container to the SoR-AF in an existing message or in a new message. When the SoR-AF receives the Uplink SoR container, the SoR AF may trigger slice based SoR procedure by sending the PLMN and slice supported by the PLMN in the priority order. The UDM executes the step as defined above to the send the Slice based SoR list to the AMF.
4. When the AMF receives the Nudm_UECM_Registration Response message containing the SoR container, the AMF sends the SoR container to the UE in the registration Accept message.
5. When the UE receives the SoR container in the registration accept message, the UE checks the integrity protection of the SoR container, if the integrity protection checks pass then the UE process the content of the SoR container depending on the content of the SoR container as below:
(I) if the SoR container contains Slice based SoR list, then the UE stores the slice based SoR list. The UE performs PLMN selection based on the slice based SoR list.
(II) if the SoR container contains only MAC header or a ACK indicator, the UE determines that the HPLMN has received the uplink SoR container.

If the UE doesn't receive any SoR container, then the UE determines that HPLMN doesn't receive the performs PLMN selection procedure based on the previously stored Slice based SoR list or SoR list. The UE man select another PLMN procedure and performs registration procedure as defined in the step 7.
6. Upon reception of the registration accept message, the UE transmits the Registration complete message.
7. The initiates registration procedure on the selected PLMN in step 5.

### Modifications and Alternatives

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

### Supplementary Notes

The whole or part of the example Aspects disclosed above can be described as, but not limited to, the following supplementary notes.
Supplementary note 1. A method of a User Equipment (UE), the method comprising:
sending a first message to a communication apparatus in a first Visited Public Land Mobile Network (VPLMN);
wherein the first message includes a request for first information,
wherein the first information indicates a network slice which is available in a second VPLMN, and
wherein the second VPLMN is different from the first VPLMN; and
performing PLMN selection in a case of not receiving the first information.
Supplementary note 2. The method according to supplementary note 1, wherein the first message is a first Registration Request message.
Supplementary note 3. The method according to supplementary note 1 or 2, further comprising:
receiving a second message including the first information from the communication apparatus in the first VPLMN in a case where the request is sent.
Supplementary note 4. The method according to supplementary note 3, wherein the second message is a first Registration Accept message.
Supplementary note 5. The method according to any one of supplementary notes 1 to 4, further comprising:
receiving a third message,
wherein the third message includes second information indicating that the communication apparatus is configured to recognize the request.
Supplementary note 6. The method according to any one of supplementary notes 1 to 4, further comprising:
performing the PLMN selection in a case of not receiving a third message,
wherein the third message includes second information indicating that the communication apparatus is configured to recognize the request.
Supplementary note 7. The method according to supplementary note 5 or 6,
wherein the third message is a second Registration Accept message.
Supplementary note 8. The method according to any one of supplementary notes 1 to 7,
wherein the communication apparatus is first Access and Mobility Management Function (AMF).
Supplementary note 9. The method according to any one of supplementary notes 1 to 8,
wherein the network slice is related to service corresponding to the UE or an application in the UE.
Supplementary note 10. The method according to any one of supplementary notes 1 to 9, further comprising:
sending a fourth message to another communication apparatus in a VPLMN selected by the PLMN selection,
wherein the fourth message includes a request for third information, and
wherein the third information indicating a network slice which is available in another VPLMN other than the selected VPLMN.
Supplementary note 11. The method according to supplementary note 10, wherein the fourth message is a second Registration Request message.
Supplementary note 12. The method according to supplementary note 10 or 11,
wherein the another communication apparatus is second AMF.
Supplementary note 13. A method of a communication apparatus in a first Visited Public Land Mobile Network (VPLMN), the method comprising:
receiving a first message:
wherein the first message includes a request for first information, and
wherein the first information indicates a network slice which is available in a second VPLMN:
sending the request to another communication apparatus:
sending the first information in a case of receiving the first information from the another communication apparatus; and
sending a second message including second information in a case of not receiving the first information from the another communication apparatus,
wherein the second information indicates that the communication apparatus is configured to recognize the request.
Supplementary note 14. The method according to supplementary note 13, wherein the first message is a Registration Request message.
Supplementary note 15. The method according to supplementary note 13 or 14,
wherein the second message is a Registration Accept message.
Supplementary note 16. The method according to any one of supplementary notes 13 to 15,
wherein the communication apparatus is Access and Mobility Management Function (AMF).
Supplementary note 17. The method according to any one of supplementary notes 13 to 16,
wherein the another communication apparatus is Unified Data Management (UDM).
Supplementary note 18. A method of a User Equipment (UE), the method comprising:
sending a first message to a communication apparatus in a first Visited Public Land Mobile Network (VPLMN),
wherein the first message includes a request for first information, wherein the first information indicates a network slice which is available in a second VPLMN, and
wherein the second VPLMN is different from the first VPLMN; and performing a registration procedure over non-3GPP access in a case of not receiving the first information.
Supplementary note 19. The method according to supplementary note 18, wherein the first message is a first Registration Request message.
Supplementary note 20. The method according to supplementary note 18 or 19, further comprising:
receiving a second message including the first information from the communication apparatus in the first VPLMN in a case where the request is sent.
Supplementary note 21. The method according to supplementary note 20, wherein the second message is a first Registration Accept message.
Supplementary note 22. The method according to any one of supplementary notes 18 to 21, further comprising:
receiving a third message,
wherein the third message includes second information indicating that the communication apparatus is configured to recognize the request.
Supplementary note 23. The method according to any one of supplementary notes 18 to 21, further comprising:
performing the registration procedure over non-3GPP access in a case of not receiving a third message,
wherein the third message includes second information indicating that the communication apparatus is configured to recognize the request.
Supplementary note 24. The method according to supplementary note 22 or 23,
wherein the third message is a second Registration Accept message.
Supplementary note 25. The method according to any one of supplementary notes 18 to 24,
wherein the network slice is related to service corresponding to the UE or an application in the UE.
Supplementary note 26. The method according to any one of supplementary notes 18 to 25,
wherein the performing the registration procedure over non-3GPP access includes sending a second Registration Request message over the non-3GPP access, and
wherein the second Registration Request message includes the request.
Supplementary note 27. A User Equipment (UE) comprising:
means for sending a first message to a communication apparatus in a first Visited Public Land Mobile Network (VPLMN):
wherein the first message includes a request for first information,
wherein the first information indicates a network slice which is available in a second VPLMN, and
wherein the second VPLMN is different from the first VPLMN; and means for performing PLMN selection in a case of not receiving the first information.
Supplementary note 28. The UE according to supplementary note 27, wherein the first message is a first Registration Request message.
Supplementary note 29. The UE according to supplementary note 27 or 28, further comprising:
means for receiving a second message including the first information from the communication apparatus in the first VPLMN in a case where the request is sent.
Supplementary note 30. The UE according to supplementary note 29, wherein the second message is a first Registration Accept message.
Supplementary note 31. The UE according to any one of supplementary notes 27 to 30, further comprising:
means for receiving a third message,
wherein the third message includes second information indicating that the communication apparatus is configured to recognize the request.
Supplementary note 32. The UE according to any one of supplementary notes 27 to 30, further comprising:
means for performing the PLMN selection in a case of not receiving a third message,
wherein the third message includes second information indicating that the communication apparatus is configured to recognize the request.
Supplementary note 33. The UE according to supplementary note 31 or 32, wherein the third message is a second Registration Accept message.
Supplementary note 34. The UE according to any one of supplementary notes 27 to 33,
wherein the communication apparatus is first Access and Mobility Management Function (AMF).
Supplementary note 35. The UE according to any one of supplementary notes 27 to 34,
wherein the network slice is related to service corresponding to the UE or an application in the UE.
Supplementary note 36. The UE according to any one of supplementary notes 27 to 35, further comprising:
means for sending a fourth message to another communication apparatus in a VPLMN selected by the PLMN selection,
wherein the fourth message includes a request for third information, and
wherein the third information indicating a network slice which is available in another VPLMN other than the selected VPLMN.
Supplementary note 37. The UE according to supplementary note 36, wherein the fourth message is a second Registration Request message.
Supplementary note 38. The UE according to supplementary note 36 or 37,
wherein the another communication apparatus is second AMF.
Supplementary note 39. A communication apparatus in a first Visited Public Land Mobile Network (VPLMN), the communication apparatus comprising:
means for receiving a first message:
wherein the first message includes a request for first information, and wherein the first information indicates a network slice which is available in a second VPLMN:
means for sending the request to another communication apparatus:
means for sending the first information in a case of receiving the first information from the another communication apparatus; and
means for sending a second message including second information in a case of not receiving the first information from the another communication apparatus,
wherein the second information indicates that the communication apparatus is configured to recognize the request.
Supplementary note 40. The communication apparatus according to supplementary note 39,
wherein the first message is a Registration Request message.
Supplementary note 41. The communication apparatus according to supplementary note 39 or 40,
wherein the second message is a Registration Accept message.
Supplementary note 42. The communication apparatus according to any one of supplementary notes 39 to 41,
wherein the communication apparatus is Access and Mobility Management Function (AMF).
Supplementary note 43. The communication apparatus according to any one of supplementary notes 39 to 42,
wherein the another communication apparatus is Unified Data Management (UDM).
Supplementary note 44. A User Equipment (UE) comprising:
means for sending a first message to a communication apparatus in a first Visited Public Land Mobile Network (VPLMN),
wherein the first message includes a request for first information, wherein the first information indicates a network slice which is available in a second VPLMN, and
wherein the second VPLMN is different from the first VPLMN; and
means for performing a registration procedure over non-3GPP access in a case of not receiving the first information.
Supplementary note 45. The UE according to supplementary note 44, wherein the first message is a first Registration Request message.
Supplementary note 46. The UE according to supplementary note 44 or 45, further comprising:
means for receiving a second message including the first information from the communication apparatus in the first VPLMN in a case where the request is sent.
Supplementary note 47. The UE according to supplementary note 46, wherein the second message is a first Registration Accept message.
Supplementary note 48. The UE according to any one of supplementary notes 44 to 47, further comprising:
means for receiving a third message,
wherein the third message includes second information indicating that the communication apparatus is configured to recognize the request.
Supplementary note 49. The UE according to any one of supplementary notes 44 to 47, further comprising:
means for performing the registration procedure over non-3GPP access in a case of not receiving a third message,
wherein the third message includes second information indicating that the communication apparatus is configured to recognize the request.
Supplementary note 50. The UE according to supplementary note 48 or 49,
wherein the third message is a second Registration Accept message.
Supplementary note 51. The UE according to any one of supplementary notes 44 to 50,
wherein the network slice is related to service corresponding to the UE or an application in the UE.
Supplementary note 52. The UE according to any one of supplementary notes 44 to 51,
wherein the performing the registration procedure over non-3GPP access includes sending a second Registration Request message over the non-3GPP access, and
wherein the second Registration Request message includes the request.

This application is based upon and claims the benefit of priority from Indian provisional patent application No. 202211062529, filed on Nov. 2, 2022, the disclosure of which is incorporated herein in its entirety by reference.

What is claimed is:

1-12. (canceled)

13. A method of a communication apparatus in a first Visited Public Land Mobile Network (VPLMN), the method comprising:
receiving a first message;
wherein the first message includes a request for first information, and
wherein the first information indicates a network slice which is available in a second VPLMN;
sending the request to another communication apparatus;
sending the first information in a case of receiving the first information from the another communication apparatus; and
sending a second message including second information in a case of not receiving the first information from the another communication apparatus,
wherein the second information indicates that the communication apparatus is configured to recognize the request.

14. The method according to claim 13,
wherein the first message is a Registration Request message.

15. The method according to claim 13,
wherein the second message is a Registration Accept message.

16. The method according to claim 13,
wherein the communication apparatus is Access and Mobility Management Function (AMF).

17. The method according to claim 13,
wherein the another communication apparatus is Unified Data Management (UDM).

18. A method of a User Equipment (UE), the method comprising:
sending a first message to a communication apparatus in a first Visited Public Land Mobile Network (VPLMN),
wherein the first message includes a request for first information,
wherein the first information indicates a network slice which is available in a second VPLMN, and
wherein the second VPLMN is different from the first VPLMN; and
performing a registration procedure over non-3GPP access in a case of not receiving the first information.

19. The method according to claim 18,
wherein the first message is a first Registration Request message.

20. The method according to claim 18, further comprising:
receiving a second message including the first information from the communication apparatus in the first VPLMN in a case where the request is sent.

21. The method according to claim 20,
wherein the second message is a first Registration Accept message.

22. The method according to claim 18, further comprising:
receiving a third message,
wherein the third message includes second information indicating that the communication apparatus is configured to recognize the request.

23. The method according to claim 18, further comprising:
performing the registration procedure over non-3GPP access in a case of not receiving a third message,
wherein the third message includes second information indicating that the communication apparatus is configured to recognize the request.

24. The method according to claim 22,
wherein the third message is a second Registration Accept message.

25. The method according to claim 18,
wherein the network slice is related to service corresponding to the UE or an application in the UE.

26. The method according to claim 18,
wherein the performing the registration procedure over non-3GPP access includes sending a second Registration Request message over the non-3GPP access, and
wherein the second Registration Request message includes the request.

27-43. (canceled)

44. A User Equipment (UE) comprising:
at least one memory; and
at least one hardware processor coupled to the at least one memory,
wherein the at least one hardware processor is configured to:
send a first message to a communication apparatus in a first Visited Public Land Mobile Network (VPLMN),
wherein the first message includes a request for first information,
wherein the first information indicates a network slice which is available in a second VPLMN, and
wherein the second VPLMN is different from the first VPLMN; and
perform a registration procedure over non-3GPP access in a case of not receiving the first information.

45-52. (canceled)
